(19) United States
(12) Patent Application Publication
(10) Pub. No.: US 2016/0295612 A1
(43) Pub. Date: Oct. 6, 2016

(54) INFORMATION SENDING METHOD AND APPARATUS

(71) Applicant: Huawei Technologies Co., Ltd., Shenzhen (CN)

(72) Inventors: Yunbo LI, Shenzhen (CN); Chixiang MA, Shanghai (CN)

(21) Appl. No.: 15/170,670

(22) Filed: Jun. 1, 2016

Related U.S. Application Data
(63) Continuation of application No. PCT/CN2013/090431, filed on Dec. 25, 2013.

(51) Int. Cl. H04W 74/08; H04W 76/04; H04W 74/00; H04W 84/12

(52) U.S. Cl. CPC H04W 74/0816; H04W 84/12; H04W 76/048; H04W 74/002

(57) ABSTRACT

Embodiments of the present invention provide an information sending method and apparatus. The information sending method in the present invention includes: performing, by a transmit station, channel contention; sending, by the transmit station, indication information after successfully obtaining a channel through contention, where the indication information is used for indicating that a receive station cannot actively initiate data transmission in at least two discontinuous time periods; and sending, by the transmit station, data in the at least two discontinuous time periods. According to the embodiments of the present invention, multiple discontinuous time periods are flexibly reserved in some discontinuous data transmission scenarios, and channel resources are saved.

### CROSS-REFERENCE TO RELATED APPLICATIONS

This application is a continuation of International Patent Application No. PCT/CN2013/090431, filed on Dec. 25, 2013, which is hereby incorporated by reference in its entirety.

### TECHNICAL FIELD

Embodiments of the present invention relate to communications technologies, and in particular, to an information sending method and apparatus.

### BACKGROUND

In a wireless local area network (Wireless Local Area Network, WLAN for short) system, multiple stations share a channel resource by using a carrier sense multiple access/collision avoidance (Carrier Sense Multiple Access with Collision Avoidance, CSMA/CA for short) contention mechanism, and when multiple user stations perform channel contention, a collision inevitably occurs. In order to reduce a collision probability, a mechanism of reserving a channel by setting a network allocation vector (Network Allocation Vector, NAV for short) is introduced, where the NAV is used for specifying an estimated time for which a transmit station needs to occupy a channel, and a station for which the NAV is set needs to maintain a silent state in a time period specified by the NAV, so as to ensure that two stations can perform communication without interference in the time period.

In the conventional art, a NAV is set for all stations surrounding a transmit end and a receive end by using a method such as an exchange of request to send and clear to send (Request to Send/Clear to Send, RTS/CTS for short) frames, to reserve a period of time starting from a current frame. When data is sent completely but there is a remaining reserved time, a contention free-end (Contention free-end, CF-end for short) frame may be sent to release all the remaining reserved time.

In the conventional art, reservation and release technologies are not very flexible, it is adverse to channel reservation and release in some discontinuous data transmission scenarios, and a waste of channel resources is caused.

### SUMMARY

Embodiments of the present invention provide an information sending method and apparatus, so as to implement flexible channel reservation and release in some discontinuous data transmission scenarios.

According to a first aspect, an embodiment of the present invention provides an information sending method, including:

performing, by a transmit station, channel contention;

sending, by the transmit station, indication information after successfully obtaining a channel through contention, where the indication information is used for indicating that a receive station cannot actively initiate data transmission in at least two discontinuous time periods; and

sending, by the transmit station, data in the at least two discontinuous time periods.

Further, before the sending, by the transmit station, data in the at least two discontinuous time periods, the method further includes:

receiving, by the transmit station, response information returned by a target station, where the response information is used for indicating that the receive station cannot actively initiate data transmission in the at least two discontinuous time periods.

Further, the indication information is sent by using one frame, where the frame includes information used for indicating the at least two discontinuous time periods; or

the indication information is sent by using at least two frames, where the at least two frames each include information used for indicating at least one time period in the at least two discontinuous time periods, and a frame in the at least two frames is sent in a time period indicated by a previous frame.

Further, before the sending, by the transmit station, indication information, the method further includes:

determining, by the transmit station, a length of each of the at least two discontinuous time periods according to a cycle of data to be sent and a volume of data to be sent in each cycle.

Further, the at least two discontinuous time periods are both used for transmitting uplink data, or are both used for transmitting downlink data, or are partially used for transmitting uplink data and partially used for transmitting downlink data.

According to a second aspect, an embodiment of the present invention provides an information sending method, including:

receiving, by a target station, indication information sent by a transmit station, where the indication information is used for indicating that the target station cannot actively initiate data transmission in at least two discontinuous time periods; and

receiving, by the target station in the at least two discontinuous time periods, data sent by the transmit station.

Further, before the receiving, by the target station in the at least two discontinuous time periods, data sent by the transmit station, the method further includes:

returning, by the target station, response information to the transmit station, where the response information is used for indicating that a receive station cannot actively initiate data transmission in the at least two discontinuous time periods.

Further, the returning, by the target station, response information to the transmit station includes:

if the indication information is sent by using one frame, sending, by the target station, one response frame to the transmit station; or

if the indication information is sent by using at least two frames, where the at least two frames each include information used for indicating at least one time period in the at least two discontinuous time periods, sending, by the target station, at least two response frames to the transmit station correspondingly.

Further, the at least two discontinuous time periods are both used for transmitting uplink data, or are both used for transmitting downlink data, or are partially used for transmitting uplink data and partially used for transmitting downlink data.

According to a third aspect, an embodiment of the present invention provides an information sending method, including:

sending, by a transmit station, indication information, where the indication information is used for indicating a reserved time period;

sending, by the transmit station, data in the reserved time period; and

sending, by the transmit station, release information in the reserved time period, where the release information is used for instructing a receive station to release at least a part of a remaining time period in the time period.

Further, the reserved time period is one continuous time period or at least two discontinuous time periods.

According to a fourth aspect, an embodiment of the present invention provides an information sending method, including:

receiving, by a receive station, indication information sent by a transmit station, where the indication information is used for indicating a reserved time period; and

receiving, by the receive station in the reserved time period, release information sent by the transmit station, where the release information is used for instructing the receive station to release at least a part of a remaining time period in the time period.

Further, the reserved time period is one continuous time period or at least two discontinuous time periods.

According to a fifth aspect, an embodiment of the present invention provides a transmit station, including:

a contention module, configured to perform channel contention;

an indication module, configured to send indication information after a channel is successfully obtained through contention, where the indication information is used for indicating that a receive station cannot actively initiate data transmission in at least two discontinuous time periods; and

a sending module, configured to send data in the at least two discontinuous time periods.

Further, the transmit station further includes:

a receiving module, configured to receive response information returned by a target station, where the response information is used for indicating that the receive station cannot actively initiate data transmission in the at least two discontinuous time periods.

Further, the indication information is sent by using one frame, where the frame includes information used for indicating the at least two discontinuous time periods; or

the indication information is sent by using at least two frames, where the at least two frames each include information used for indicating at least one time period in the at least two discontinuous time periods, and a frame in the at least two frames is sent in a time period indicated by a previous frame.

Further, the transmit station further includes:

a determining module, configured to determine a length of each of the at least two discontinuous time periods according to a cycle of data to be sent and a volume of data to be sent in each cycle.

Further, the at least two discontinuous time periods are both used for transmitting uplink data, or are both used for transmitting downlink data, or are partially used for transmitting uplink data and partially used for transmitting downlink data.

According to a sixth aspect, an embodiment of the present invention provides a target station, including:

a first receiving module, configured to receive indication information sent by a transmit station, where the indication information is used for indicating that the target station cannot actively initiate data transmission in at least two discontinuous time periods; and

a second receiving module, configured to receive, in the at least two discontinuous time periods, data sent by the transmit station.

Further, the target station further includes:

a returning module, configured to return response information to the transmit station, where the response information is used for indicating that a receive station cannot actively initiate data transmission in the at least two discontinuous time periods.

Further, the returning module is specifically configured to: if the indication information is sent by using one frame, send one response frame to the transmit station; or

if the indication information is sent by using at least two frames, where the at least two frames each include information used for indicating at least one time period in the at least two discontinuous time periods, send at least two response frames to the transmit station correspondingly.

Further, the at least two discontinuous time periods are both used for transmitting uplink data, or are both used for transmitting downlink data, or are partially used for transmitting uplink data and partially used for transmitting downlink data.

According to a seventh aspect, an embodiment of the present invention provides a transmit station, including:

an indication module, configured to send indication information, where the indication information is used for indicating a reserved time period;

a first sending module, configured to send data in the reserved time period; and

a second sending module, configured to send release information in the reserved time period, where the release information is used for instructing a receive station to release at least a part of a remaining time period in the time period.

Further, the reserved time period is one continuous time period or at least two discontinuous time periods.

According to an eighth aspect, an embodiment of the present invention provides a receive station, including:

a first receiving module, configured to receive indication information sent by a transmit station, where the indication information is used for indicating a reserved time period; and

a second receiving module, configured to receive, in the reserved time period, release information sent by the transmit station, where the release information is used for instructing the receive station to release at least a part of a remaining time period in the time period.

Further, the reserved time period is one continuous time period or at least two discontinuous time periods.

In the embodiments, a transmit station sends indication information used for indicating that a receive station cannot actively initiate data transmission in at least two discontinuous time periods, and sends data in the at least two discontinuous time periods, so that multiple discontinuous time periods can be flexibly reserved by performing channel contention once, so as to implement channel reservation in some discontinuous data transmission scenarios, contention overheads are reduced, and channel resources are saved.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1 is a schematic flowchart of Embodiment 1 of an information sending method according to the present invention;

FIG. 2 is a schematic diagram 1 of Embodiment 1 of the information sending method according to the present invention;

FIG. 3 is a schematic diagram 2 of Embodiment 1 of the information sending method according to the present invention;

FIG. 4 is a schematic diagram 3 of Embodiment 1 of the information sending method according to the present invention;

FIG. 5 is a schematic diagram 4 of Embodiment 1 of the information sending method according to the present invention;

FIG. 6 is a schematic diagram 5 of Embodiment 1 of the information sending method according to the present invention;

FIG. 7 is a schematic flowchart of Embodiment 2 of an information sending method according to the present invention;

FIG. 8 is a schematic flowchart of Embodiment 3 of an information sending method according to the present invention;

FIG. 9 is a schematic diagram 1 of Embodiment 3 of the information sending method according to the present invention;

FIG. 10 is a schematic diagram 2 of Embodiment 3 of the information sending method according to the present invention;

FIG. 11 is a schematic flowchart of Embodiment 4 of an information sending method according to the present invention;

FIG. 12 is a schematic flowchart of Embodiment 5 of an information sending method according to the present invention;

FIG. 13 is a schematic diagram 1 of Embodiment 5 of the information sending method according to the present invention;

FIG. 14 is a schematic diagram 2 of Embodiment 5 of the information sending method according to the present invention;

FIG. 15 is a schematic flowchart of Embodiment 6 of an information sending method according to the present invention;

FIG. 16 is a schematic flowchart of Embodiment 7 of an information sending method according to the present invention;

FIG. 17 is a schematic flowchart of Embodiment 8 of an information sending method according to the present invention;

FIG. 18 is a schematic structural diagram of Embodiment 1 of a transmit station according to the present invention;

FIG. 19 is a schematic structural diagram of Embodiment 2 of a transmit station according to the present invention;

FIG. 20 is a schematic structural diagram of Embodiment 3 of a transmit station according to the present invention;

FIG. 21 is a schematic structural diagram of Embodiment 4 of a transmit station according to the present invention;

FIG. 22 is a schematic structural diagram of Embodiment 1 of a target station according to the present invention;

FIG. 23 is a schematic structural diagram of Embodiment 2 of a target station according to the present invention;

FIG. 24 is a schematic structural diagram of Embodiment 3 of a target station according to the present invention;

FIG. 25 is a schematic structural diagram of Embodiment 4 of a target station according to the present invention;

FIG. 26 is a schematic structural diagram of Embodiment 5 of a transmit station according to the present invention;

FIG. 27 is a schematic structural diagram of Embodiment 6 of a transmit station according to the present invention;

FIG. 28 is a schematic structural diagram of Embodiment 7 of a transmit station according to the present invention;

FIG. 29 is a schematic structural diagram of Embodiment 8 of a transmit station according to the present invention;

FIG. 30 is a schematic structural diagram of Embodiment 1 of a receive station according to the present invention;

FIG. 31 is a schematic structural diagram of Embodiment 2 of a receive station according to the present invention;

FIG. 32 is a schematic structural diagram of Embodiment 3 of a receive station according to the present invention; and

FIG. 33 is a schematic structural diagram of Embodiment 4 of a receive station according to the present invention.

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

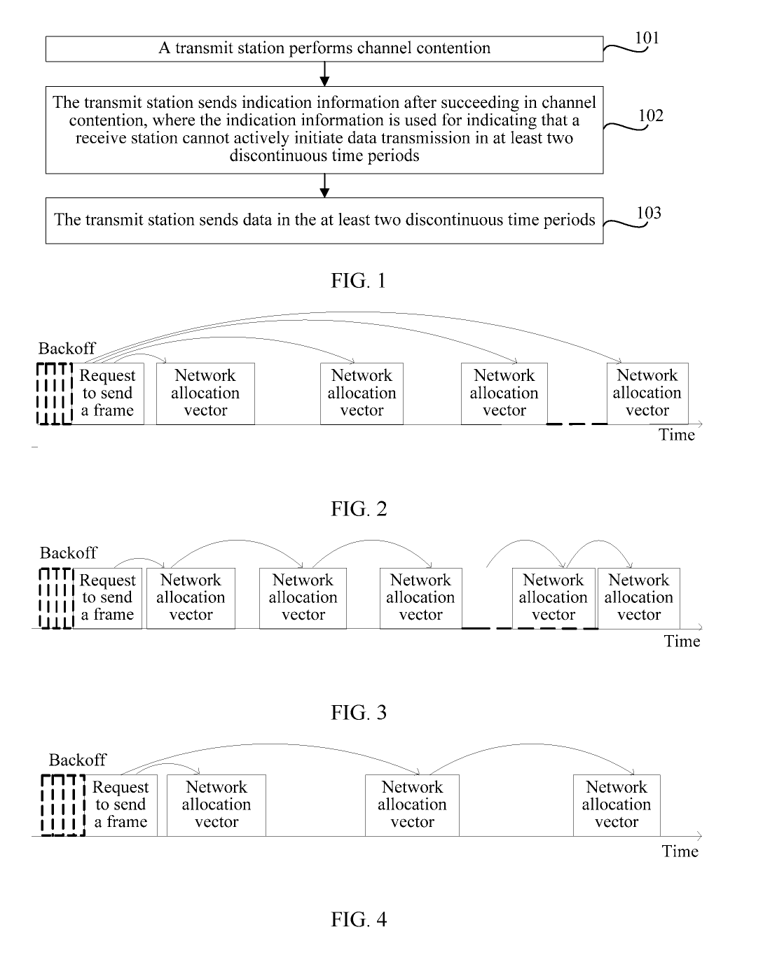

FIG. 1 is a schematic flowchart of Embodiment 1 of an information sending method according to the present invention. As shown in FIG. 1, the method in this embodiment may include the following steps:

Step 101: A transmit station performs channel contention.

In a WLAN system, multiple stations share a channel resource by using a CSMA/CA contention mechanism, that is, channel contention needs to be first performed when a station needs to send data. A basic principle of the CSMA/CA contention mechanism is that, before sending data, each station first senses whether a channel is in a busy state or an idle state, and backoff counting is started only when the channel is idle for a particular time length (for example, a DIFS), and collisions can be reduced in a backoff manner. A value of backoff counting is randomly selected and obtained from a backoff window. Before a value of a backoff counter is reduced to zero at a particular time and when the channel is busy again, backoff counting is suspended, and after the channel is idle for particular duration next time, backoff counting continues to be performed. The foregoing process is repeated until the value of the backoff counter is reduced to zero, that is, backoff counting ends, and it indicates that the transmit station succeeds in channel contention.

Step 102: The transmit station sends indication information after successfully obtaining a channel through contention, where the indication information is used for indicating that a receive station cannot actively initiate data transmission in at least two discontinuous time periods.

Specifically, the indication information may be sent by using one frame, where the frame includes information used for indicating the at least two discontinuous time periods; or the indication information is sent by using at least two frames, where the at least two frames each include information used for indicating at least one time period in the at least two discontinuous time periods, and a frame in the at least two frames is sent in a time period indicated by a previous frame.

In this embodiment, the transmit station sends the indication information after successfully obtaining a channel through contention, where the indication information is used for indicating that a receive station (that is, a station that receives the indication information) cannot actively initiate data transmission in the at least two discontinuous time periods. Optionally, the indication information may be a reserved frame such as an RTS frame or a CTS-to-self frame or a data frame, where a MAC header of each of these reserved frames carries a field used for setting a NAV, for example, a Duration field.

Optionally, the indication information may be sent by using one frame, where the frame includes information used for indicating the at least two discontinuous time periods; or the indication information is sent by using at least two frames, where the at least two frames each include information used for indicating at least one time period in the at least two discontinuous time periods, and a frame in the at least two frames is sent in a time period indicated by a previous frame.

Specifically, a first implementable manner is: when the indication information may be sent by using one reserved frame, a MAC header of the reserved frame carries one or more Duration fields. When one Duration field is carried, the Duration field corresponds to at least two different start moments, that is, the reserved frame includes information used for indicating the at least two discontinuous time periods; and a second implementable manner is: when the indication information may be sent by using at least two reserved frames, a MAC header of each of these reserved frames carries one or more Duration fields, that is, the at least two reserved frames each include information used for indicating at least one time period in the at least two discontinuous time periods, and a latter reserved frame in the at least two reserved frames is sent in a time period indicated by a former reserved frame.

These reserved frames are used for indicating that a receive station that receives the reserved frames cannot actively initiate data transmission in the at least two discontinuous time periods, so as to successfully reserve the at least two discontinuous time periods. The receive station includes a target station (a station to which the transmit station needs to send data) and a non-target station (a receive station except the target station). After receiving these reserved frames, the non-target station sets duration indicated by each of these Duration fields to a NAV value, and ensures that the non-target station does not actively perform any transmission in the at least two discontinuous time periods (that is, in a NAV time), and does not perform transmission even if a channel is idle. A NAV time is referred to as a transmission opportunity (Transmission opportunity, TXOP for short), and a station that successfully sets a NAV for another station is referred to as a transmission opportunity holder (Transmission opportunity holder, TXOP holder for short). Optionally, reserved time period information may be obtained according to information in an actual situation, for example, for a cyclic service, may be determined according to information such as a length of a reserved time needed in each cycle; for uplink and downlink services, may be determined according to information such as a known division method in the uplink and downlink services and a length of a reserved time needed in uplink and downlink time periods; and for some services in which information such as a time period that needs to be reserved may be determined according to known statistical summary information, may be determined according to statistical information.

Optionally, in this embodiment, after successfully obtaining a channel through contention, the transmit station sends the indication information by using one reserved frame, where the reserved frame may use a different frame format, for example, a format such as “a start time 1+duration 1+a start time 2+duration 2+ . . . +a start time n+duration n” or “a start time 1+an end time 1+a start time 2+an end time 2+ . . . +a start time n+an end time n”, where n may be determined according to a specific actual situation, and time information therein is obtained according to an actual application situation. Further, if a start time is omitted in the format of the reserved frame, the start time may be the default, for example, starting when a current frame ends.

Optionally, in this embodiment, methods for sending, by the transmit station by using the at least two frames, the indication information after successfully obtaining a channel through contention may include two types of methods: simultaneous multi-period reservation and stepwise multi-period reservation. In a simultaneous multi-period reservation technology, after successfully obtaining a channel through contention, the transmit station may send one reserved frame used for indicating that the receive station cannot actively initiate data transmission in the at least two discontinuous time periods, to implement simultaneous reservation of multiple discontinuous time periods. In a stepwise multi-period reservation technology, after successfully obtaining a channel through contention, the transmit station may send, at intervals, at least two reserved frames used for indicating that the receive station cannot actively initiate data transmission in the at least one time period in the at least two discontinuous time periods, where a latter reserved frame in the at least two reserved frames is sent in a time period indicated by a former reserved frame.

In the first simultaneous multi-period reservation technology, FIG. 2 is a schematic diagram 1 of Embodiment 1 of the information sending method according to the present invention. As shown in FIG. 2, in this embodiment, after successfully obtaining a channel through contention, that is, after backoff counting ends, the transmit station sends one RTS frame, where a MAC header of the RTS frame carries at least two Duration fields or one Duration field, which corresponds to multiple different start moments, and the field is used for setting a NAV, that is, the RTS frame is used for indicating that the receive station cannot actively initiate data transmission in the at least two discontinuous time periods, that is, after receiving the frame, the non-target station sets duration indicated by each of these Duration fields to a NAV value, and ensures that the non-target station does not perform any transmission in the set at least two discontinuous time periods (that is, in a NAV time), and does not perform transmission even if a channel is idle.

For the second stepwise multi-period reservation technology, FIG. 3 is a schematic diagram 2 of Embodiment 1 of the information sending method according to the present invention. As shown in FIG. 3, in this embodiment, after successfully obtaining a channel through contention, that is, after backoff counting ends, the transmit station first sends one RTS frame, where a MAC header of the RTS frame carries one Duration field, and the field is used for setting a NAV, that is, the RTS frame is used for indicating that the receive station cannot actively initiate data transmission in the time period, that is, after receiving the frame, the non-target station sets duration indicated by the Duration field to a NAV value, and ensures that the non-target station does not perform any transmission in the set time period (that is, in a NAV time). Optionally, a next reserved time may be set in the reserved time according to the foregoing method, and therefore, more time periods are reserved continually.

For the second stepwise multi-period reservation technology, FIG. 4 is a schematic diagram 3 of Embodiment 1 of the information sending method according to the present invention. As shown in FIG. 4, an example in which a first reserved frame is used for indicating that the receive station cannot actively initiate data transmission in the at least two discontinuous time periods, and a second reserved frame is sent in a time period indicated by the first reserved frame and is used for indicating that the receive station cannot actively initiate data transmission in one time period is used. After successfully obtaining a channel through contention, that is, after backoff counting ends, the transmit station first sends one RTS frame, where a MAC header of the RTS frame carries two Duration fields, and the field is used for setting a NAV, that is, the frame indicates that the receive station cannot actively initiate data transmission in the at least two discontinuous time periods, that is, after receiving the frame, the non-target station sets duration indicated by each of these Duration fields to a NAV value, and ensures that the non-target station does not perform any transmission in the set time period (that is, in a NAV time); and then, the transmit station sends another RTS frame in a reserved second time, where a MAC header of the RTS frame carries one Duration field, the Duration field includes information about one time period, and the field is used for setting a NAV, that is, the frame indicates that the receive station cannot actively initiate data transmission in the time period, so as to indicate that the receive station cannot actively initiate data transmission in the at least two discontinuous time periods, so that the at least two discontinuous time periods are successfully reserved.

However, in the conventional art, only one continuous time period can be reserved by performing channel contention once, and for some discontinuous data transmission scenarios, channel contention needs to be performed each time, and therefore, contention overheads are very large. In this embodiment, an objective of sending a reserved frame that can be used for reserving at least two discontinuous time periods after a channel is successfully obtained through contention once is to implement that the at least two discontinuous time periods can be reserved at one time after channel contention is performed once in some discontinuous data transmission scenarios, thereby reducing contention overheads. Discontinuous data transmission may occur in many scenarios, and in the following descriptions of this embodiment, two typical scenarios: a cyclic service scenario and an uplink and downlink communication scenario are used as an example to further explain and describe the foregoing technical solutions of this embodiment.

In the cyclic service scenario, further, before sending, by the transmit station, a channel reserved frame, the method may further include:

determining, by the transmit station, a length of each of the at least two discontinuous time periods according to a cycle of service data to be sent and a volume of data to be sent in each cycle.

In this embodiment, the transmit station determines, according to the cycle of the service data to be sent and the volume of the data to be sent in each cycle, a length of a reserved time period needed in each cycle, to write, when a reserved frame is sent in a next step, information about the foregoing determined reserved time period in the reserved frame, so as to implement reservation of multiple time periods.

In the first simultaneous multi-period reservation technology, after successfully obtaining a channel through contention, the transmit station sends one channel reserved frame, where the channel reserved frame may use the different frame format as described above, which, for example, may also be “a cycle length+a cycle quantity+a start time+a length of a reserved time in each cycle”. In the uplink and downlink communication scenario in which multiple access points are deployed, in order to reduce uplink and downlink cross interference between different base station subsystems (Base Station Subsystem, BSS for short), a communication time is divided into uplink and downlink periods. When both uplink data and downlink data exist, but the data does not need to occupy all uplink and downlink time periods, discontinuous uplink and downlink transmission occurs, and if uplink contention and downlink contention are performed separately, contention overheads are increased.

In this embodiment, when a channel is obtained, both an uplink time period and a downlink time period may be reserved. For example, when obtaining a channel by means of contention, an access node (Access Point, AP for short) may reserve a part of an uplink time or a part of a downlink time or a part or all of an uplink time and a downlink time, that is, in step 102, the at least two discontinuous time periods are both used for transmitting uplink data, or are both used for transmitting downlink data, or are partially used for transmitting uplink data and partially used for transmitting downlink data.

In this embodiment, because the communication time is divided into the uplink and downlink periods, it may be considered that there is a fixed cycle; therefore, it may be considered that it is a particular case in the cyclic service scenario. It is determined, according to an actual situation, that only a time period for transmitting uplink data needs to be reserved, only a time period for transmitting downlink data needs to be reserved, or a part of a time period for transmitting uplink data and a part of a time period for transmitting downlink data need to be reserved, so that the channel reserved frame includes corresponding information about reserved data.

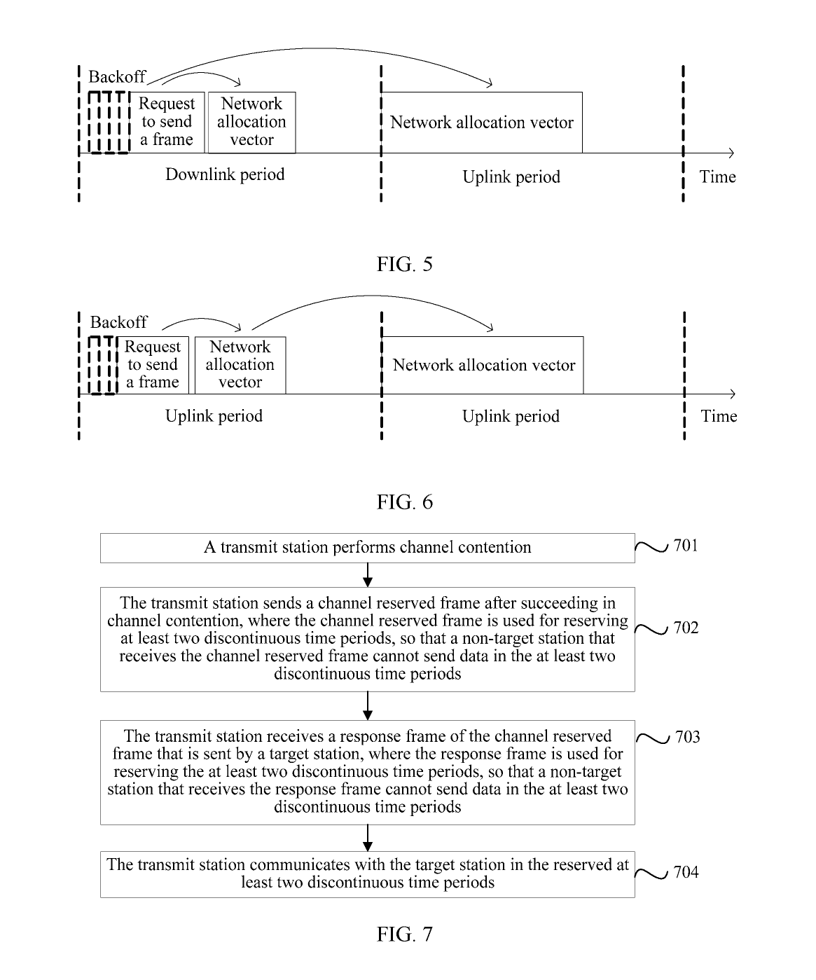

For the first simultaneous multi-period reservation technology, FIG. 5 is a schematic diagram 4 of Embodiment 1 of the information sending method according to the present invention. As shown in FIG. 5, an example in which only two discontinuous time periods for uplink and downlink transmission are reserved is used. After successfully obtaining a channel through contention, that is, after backoff counting ends, the transmit station sends one RTS frame, where a MAC header of the RTS frame carries two Duration fields, and the field is used for setting a NAV, that is, the channel reserved frame is used for reserving two discontinuous time periods in uplink and downlink communication, that is, a downlink period (Downlink period, DL period for short) and an uplink period (Uplink period, UL period for short), so that after receiving the channel reserved frame, the non-target station sets duration indicated by each of these Duration fields to a NAV value, and ensures that the non-target station does not perform any transmission in the set two discontinuous time periods (that is, in a NAV time), and does not perform transmission even if a channel is idle.

For a first implementable manner of the second stepwise multi-period reservation technology, FIG. 6 is a schematic diagram 5 of Embodiment 1 of the information sending method according to the present invention. As shown in FIG. 6, an example in which only two discontinuous time periods for uplink and downlink transmission are reserved is used. After successfully obtaining a channel through contention, that is, after backoff counting ends, the transmit station first sends one RTS frame, where a MAC header of the RTS frame carries one Duration field, and the field is used for setting a NAV, that is, the channel reserved frame is used for reserving one time period in uplink communication, that is, an uplink period (Uplink period, UL period for short), so that after receiving the channel reserved frame, the non-target station sets duration indicated by the Duration field to a NAV value, and ensures that the non-target station does not perform any transmission in the set time period (that is, in a NAV time); and then, in the reserved time, a reserved time for downlink communication, that is, a downlink period (Downlink period, DL period for short), is set according to the foregoing method.

In this embodiment, the two typical scenarios: the cyclic service scenario and the uplink and downlink communication scenario are used as an example to further explain and describe the foregoing technical solutions of this embodiment, and for another discontinuous transmission scenario, the foregoing method may be used to implement a multi-period reservation technology after contention is performed once, and details are not described herein again.

In this embodiment, in a simultaneous multi-period reservation mechanism, in order to prevent a station from reserving too many resources to affect communication of another station, some limiting conditions may be added, for example, a total length of a time that is reserved each time is limited, or a quantity of time periods that are reserved each time is limited.

Step 103: The transmit station sends data in the at least two discontinuous time periods.

In this embodiment, the transmit station sends the indication information after successfully obtaining a channel through contention, where the indication information is used for indicating that the receive station cannot actively initiate data transmission in the at least two discontinuous time periods, that is, a NAV is set for the non-target station, so that a station for which a NAV is set maintains a silent state in a NAV time, so as to ensure that another station does not interfere with data sending of the transmit station in the reserved at least two discontinuous time periods.

Optionally, before the sending, by the transmit station, data in the at least two discontinuous time periods, the method further includes: receiving, by the transmit station, response information returned by a target station, where the response information is used for indicating that the receive station cannot actively initiate data transmission in the at least two discontinuous time periods.

In this embodiment of the present invention, the transmit station receives response information that is returned by the target station after the target station correctly receives the channel reserved frame sent by the transmit station, where the response information may correspondingly be a response frame such as a CTS frame corresponding to an RTS frame, or an ACK frame corresponding to a data frame, a MAC header of each of these response frames also carries a Duration field, according to the channel reserved frame, the Duration field and the Duration field that is carried in the MAC header of the reserved frame sent by the transmit station and that is used for setting a NAV may have a same format, or may have different formats but are used for reserving a same time period, and the response frame may be used for indicating that a receive station (a station that receives the response frame) cannot actively initiate data transmission in the at least two discontinuous time periods, that is, a NAV is set for the receive station of the response frame, so that a NAV is set for all stations except the transmit station and the target station, and it is ensured that the transmit station can communicate with the target station without interference in the reserved time period. Optionally, the receive station of the response frame may be the same as the receive station of the reserved frame, but even if the receive station of the response frame may be the same as the receive station of the reserved frame, in this application, it can be ensured that the NAV is set for all the stations except the transmit station and the target station; therefore, this embodiment does not impose a limit herein.

After a NAV is set for a station, before a current NAV ends, if the station receives a frame carrying a longer NAV, the station updates the NAV; if the newly received NAV is shorter than the NAV set for the station, the station does not needs to perform updating.

In this embodiment, an example of setting a NAV is used to describe a process of reserving the at least two discontinuous time periods, but the present invention is not limited thereto.

In this embodiment, a transmit station sends indication information used for indicating that a receive station cannot actively initiate data transmission in at least two discontinuous time periods, and sends data in the at least two discontinuous time periods, so that multiple discontinuous time periods can be flexibly reserved by performing channel contention once to implement channel reservation in some discontinuous data transmission scenarios, contention overheads are reduced, and channel resources are saved.

FIG. 7 is a schematic flowchart of Embodiment 2 of an information sending method according to the present invention. As shown in FIG. 7, the method in this embodiment may include the following steps:

Step 701: A transmit station performs channel contention.

Step 702: The transmit station sends a channel reserved frame after successfully obtaining a channel through contention, where the channel reserved frame is used for reserving at least two discontinuous time periods, so that a non-target station that receives the channel reserved frame cannot send data in the at least two discontinuous time periods.

Specifically, the transmit station sends one channel reserved frame after successfully obtaining a channel through contention, where the channel reserved frame is used for reserving the at least two discontinuous time periods; or the transmit station sends at least two channel reserved frames at intervals after successfully obtaining a channel through contention, where at least one channel reserved frame is used for reserving one time period or reserving the at least two discontinuous time periods at one time, at least one channel reserved frame is sent in a time period reserved by using a former channel reserved frame and is used for reserving one time period or reserving the at least two discontinuous time periods at one time, and the reserved time periods are discontinuous.

In this embodiment, the transmit station sends the channel reserved frame after successfully obtaining a channel through contention, where the channel reserved frame may be an RTS frame, a CTS-to-self frame, a data frame, or the like, and a MAC header of the channel reserved frame carries a field used for setting a NAV, for example, a Duration field. There may be one or more channel reserved frames. Correspondingly, when there is one channel reserved frame, a MAC header of the channel reserved frame may carry one or more Duration fields. When one Duration field is carried, the Duration field corresponds to multiple different start moments. When there are multiple channel reserved frames, a MAC header of the channel reserved frame may carry one or more Duration fields. That is, the channel reserved frame is used for reserving the at least two discontinuous time periods, so that after receiving the channel reserved frame, the non-target station (a receive station except a target station of the channel reserved frame) sets duration indicated by each of these Duration fields to a NAV value, and ensures that the non-target station does not perform nay transmission in the at least two discontinuous time periods (that is, in a NAV time), and does not perform transmission even if a channel is idle. A NAV time is referred to as a transmission opportunity (Transmission opportunity, TXOP for short), and a station that successfully sets a NAV for another station is referred to as a transmission opportunity holder (Transmission opportunity holder, TXOP holder for short). Reserved time period information may be obtained according to information in an actual situation, for example, for a cyclic service, may be determined according to information such as a length of a reserved time needed in each cycle; for uplink and downlink services, may be determined according to information such as a known division method in the uplink and downlink services and a length of a reserved time needed in uplink and downlink time periods; and for some services in which information such as a time period that needs to be reserved may be determined according to known statistical summary information, may be determined according to statistical information.

In this embodiment, after successfully obtaining a channel through contention, the transmit station sends one channel reserved frame, where the channel reserved frame may use a different frame format, for example, a format such as “a start time 1+duration 1+a start time 2+duration 2+ . . . +a start time n+duration n” or “a start time 1+an end time 1+a start time 2+an end time 2+ . . . +a start time n+an end time n”, where n may be determined according to a specific actual situation, and time information therein is obtained according to an actual application situation. Further, if a start time is omitted in the format of the channel reserved frame, the start time may be the default, for example, starting when a current frame ends.

In this embodiment, methods for sending, by the transmit station, the channel reserved frame after successfully obtaining a channel through contention, to reserve the at least two discontinuous time periods may include two types of methods: simultaneous multi-period reservation and stepwise multi-period reservation. In a simultaneous multi-period reservation technology, after successfully obtaining a channel through contention, the transmit station may send one channel reserved frame used for reserving the at least two discontinuous time periods, to implement simultaneous reservation of multiple discontinuous time periods. In a stepwise multi-period reservation technology, after successfully obtaining a channel through contention, the transmit station may send at least two channel reserved frames at intervals, where at least one channel reserved frame is used for reserving one time period or reserving the at least two discontinuous time periods at one time, at least one channel reserved frame is sent in a time period reserved by using a former channel reserved frame and is used for reserving one time period or reserving the at least two discontinuous time periods at one time, and the reserved time periods are discontinuous.

In a first simultaneous multi-period reservation technology, in this embodiment, after successfully obtaining a channel through contention, that is, after backoff counting ends, the transmit station sends one RTS frame, where a MAC header of the RTS frame carries at least two Duration fields or one Duration field, which corresponds to multiple different start moments, and the field is used for setting a NAV, that is, the channel reserved frame is used for reserving the at least two discontinuous time periods, so that after receiving the channel reserved frame, the non-target station sets duration indicated by each of these Duration fields to a NAV value, and ensures that the non-target station does not perform any transmission in the set at least two discontinuous time periods (that is, in a NAV time), and does not perform transmission even if a channel is idle. Details are similar to those in FIG. 2, and refer to FIG. 2.

In a second stepwise multi-period reservation technology, in this embodiment, that the transmit station sends at least two channel reserved frames at intervals after successfully obtaining a channel through contention includes five implementation manners. In a first implementable manner, each channel reserved frame is used for reserving one time period, where a latter channel reserved frame is sent in a time period reserved by using a former channel reserved frame, and the reserved time periods are discontinuous. In a second implementable manner, at least one channel reserved frame is used for reserving one time period, at least one channel reserved frame is sent in a time period reserved by using a former channel reserved frame and is used for reserving one time period, and the reserved time periods are discontinuous. In a third implementable manner, at least one channel reserved frame is used for reserving one time period, at least one channel reserved frame is sent in a time period reserved by using a former channel reserved frame and is used for reserving the at least two discontinuous time periods at one time, and the reserved time periods are discontinuous. In a fourth implementable manner, at least one channel reserved frame is used for reserving the at least two discontinuous time periods at one time, at least one channel reserved frame is sent in a time period reserved by using a former channel reserved frame and is used for reserving one time period, and the reserved time periods are discontinuous. In a fifth implementable manner, at least one channel reserved frame is used for reserving the at least two discontinuous time periods at one time, at least one channel reserved frame is sent in a time period reserved by using a former channel reserved frame and is used for reserving the at least two discontinuous time periods at one time, and the reserved time periods are discontinuous.

For the first implementable manner of the second stepwise multi-period reservation technology, in this embodiment, after successfully obtaining a channel through contention, that is, after backoff counting ends, the transmit station first sends one RTS frame, where a MAC header of the RTS frame carries one Duration field, and the field is used for setting a NAV, that is, the channel reserved frame is used for reserving one time period, so that after receiving the channel reserved frame, the non-target station sets duration indicated by the Duration field to a NAV value, and ensures that the non-target station does not perform any transmission in the set time period (that is, in a NAV time). Optionally, a next reserved time may be set in the reserved time according to the foregoing method, and therefore, more time periods are reserved continually. Details are similar to those in FIG. 3, and refer to FIG. 3.

For the fourth implementable manner of the second stepwise multi-period reservation technology, at least one channel reserved frame is used for reserving the at least two discontinuous time periods at one time, at least one channel reserved frame is sent in a time period reserved by using a former channel reserved frame and is used for reserving one time period, and another channel reserved frame may be used for reserving one time period or the at least two discontinuous time periods, which is not particularly limited herein in the present invention.

In this embodiment, an example in which a first channel reserved frame is used for reserving two discontinuous time periods at one time, and a second channel reserved frame is sent in a time period reserved by using the first channel reserved frame and is used for reserving one time period is used. After successfully obtaining a channel through contention, that is, after backoff counting ends, the transmit station first sends one RTS frame, where a MAC header of the RTS frame carries two Duration fields, and the field is used for setting a NAV, that is, the channel reserved frame is used for reserving two discontinuous time periods, so that after receiving the channel reserved frame, the non-target station sets duration indicated by each of these Duration fields to a NAV value, and ensures that the non-target station does not perform any transmission in the set time period (that is, in a NAV time); and then, a next reserved time is set in the reserved second time according to a method similar to the foregoing method. Details are similar to those in FIG. 4, and refer to FIG. 4.

However, in the conventional art, only one continuous time period can be reserved by performing channel contention once, and for some discontinuous data transmission scenarios, channel contention needs to be performed each time, and therefore, contention overheads are very large. In this embodiment, an objective of sending a channel reserved frame that can be used for reserving at least two discontinuous time periods after a channel is successfully obtained through contention once is to implement that the at least two discontinuous time periods can be reserved at one time after channel contention is performed once in some discontinuous data transmission scenarios, thereby reducing contention overheads. Discontinuous data transmission may occur in many scenarios, and in the following descriptions of this embodiment, two typical scenarios: a cyclic service scenario and an uplink and downlink communication scenario are used as an example to further explain and describe the foregoing technical solutions of this embodiment.

In the cyclic service scenario, further, before sending, by the transmit station, a channel reserved frame, the method may further include:

determining, by the transmit station according to a cycle of service data to be sent and a volume of data to be sent in each cycle, a length of a reserved time period needed in each cycle, where the at least two discontinuous time periods are discontinuous time periods corresponding to each cycle.

In this embodiment, the transmit station determines, according to the cycle of the service data to be sent and the volume of the data to be sent in each cycle, the length of the reserved time period needed in each cycle, to write, when a channel reserved frame is sent in a next step, information about the foregoing determined reserved time period in the channel reserved frame, so as to implement reservation of multiple time periods.

In the first simultaneous multi-period reservation technology, after successfully obtaining a channel through contention, the transmit station sends one channel reserved frame, where the channel reserved frame may use the different frame format as described above, which, for example, may also be “a cycle length+a cycle quantity+a start time+a length of a reserved time in each cycle”. In the uplink and downlink communication scenario in which multiple access points are deployed, in order to reduce uplink and downlink cross interference between different base station subsystems (Base Station Subsystem, BSS for short), a communication time is divided into uplink and downlink periods. When both uplink data and downlink data exist, but the data does not need to occupy all uplink and downlink time periods, discontinuous uplink and downlink transmission occurs, and if uplink contention and downlink contention are performed separately, contention overheads are increased.

In this embodiment, when a channel is obtained, both an uplink time period and a downlink time period may be reserved. For example, when obtaining a channel by means of contention, an access node (Access Point, AP for short) may reserve a part of an uplink time or a part of a downlink time or a part or all of an uplink time and a downlink time, that is, in step 702, the at least two discontinuous time periods are both used for transmitting uplink data, or are both used for transmitting downlink data, or are partially used for transmitting uplink data and partially used for transmitting downlink data.

In this embodiment, because the communication time is divided into the uplink and downlink periods, it may be considered that there is a fixed cycle; therefore, it may be considered that it is a particular case in the cyclic service scenario. It is determined, according to an actual situation, that only a time period for transmitting uplink data needs to be reserved, only a time period for transmitting downlink data needs to be reserved, or a part of a time period for transmitting uplink data and a part of a time period for transmitting downlink data need to be reserved, so that the channel reserved frame includes corresponding information about reserved data.

For the first simultaneous multi-period reservation technology, in this embodiment, an example in which only two discontinuous time periods for uplink and downlink transmission are reserved is used. After successfully obtaining a channel through contention, that is, after backoff counting ends, the transmit station sends one RTS frame, where a MAC header of the RTS frame carries two Duration fields, and the field is used for setting a NAV, that is, the channel reserved frame is used for reserving two discontinuous time periods in uplink and downlink communication, that is, a downlink period and an uplink period, so that after receiving the channel reserved frame, the non-target station sets duration indicated by each of these Duration fields to a NAV value, and ensures that the non-target station does not perform any transmission in the set two discontinuous time periods (that is, in a NAV time), and does not perform transmission even if a channel is idle. Details are similar to those in FIG. 5, and refer to FIG. 5.

For the first implementable manner of the second stepwise multi-period reservation technology, in this embodiment, an example in which only two discontinuous time periods for uplink and downlink transmission are reserved is used. After successfully obtaining a channel through contention, that is, after backoff counting ends, the transmit station first sends one RTS frame, where a MAC header of the RTS frame carries one Duration field, and the field is used for setting a NAV, that is, the channel reserved frame is used for reserving one time period in uplink communication, that is, an uplink period, so that after receiving the channel reserved frame, the non-target station sets duration indicated by the Duration field to a NAV value, and ensures that the non-target station does not perform any transmission in the set time period (that is, in a NAV time); and then, in the reserved time, a reserved time for downlink communication, that is, a downlink period, is set according to the foregoing method. Details are similar to those in FIG. 6, and refer to FIG. 6.

In this embodiment, the two typical scenarios: the cyclic service scenario and the uplink and downlink communication scenario are used as an example to further explain and describe the foregoing technical solutions of this embodiment, and for another discontinuous transmission scenario, the foregoing method may be used to implement a multi-period reservation technology after contention is performed once, and details are not described herein again.

In this embodiment, in a simultaneous multi-period reservation mechanism, in order to prevent a station from reserving too many resources to affect communication of another station, some limiting conditions may be added, for example, a total length of a time that is reserved each time is limited, or a quantity of time periods that are reserved each time is limited.

Step 703: The transmit station receives a response frame of the channel reserved frame that is sent by a target station, where the response frame is used for reserving the at least two discontinuous time periods, so that a non-target station that receives the response frame cannot send data in the at least two discontinuous time periods.

In this embodiment, the transmit station receives the response frame that is returned by the target station after the target station correctly receives the channel reserved frame sent by the transmit station, where the response frame may correspondingly be a CTS frame corresponding to an RTS frame, an ACK frame corresponding to a data frame, or have another frame, a MAC header of the response frame also carries a Duration field, according to the channel reserved frame, the Duration field and the Duration field that is carried in the MAC header of the channel reserved frame sent by the transmit station and that is used for setting a NAV may have a same format, or may have different formats but are used for reserving a same time period, and the response frame may be used for reserving the at least two discontinuous time periods, so that the non-target station that receives the response frame cannot send data in the at least two discontinuous time periods, that is, a NAV is set for a non-target station surrounding the target station.

Step 704: The transmit station communicates with the target station in the reserved at least two discontinuous time periods.

In this embodiment, the transmit station sets a NAV for the non-target station by sending the channel reserved frame, so that a station for which a NAV is set maintains a silent state in a NAV time, so as to ensure that the transmit station can communicate with the target station without interference in the reserved at least two discontinuous time periods.

After a NAV is set for a station, before a current NAV ends, if the station receives a frame carrying a longer NAV, the station updates the NAV; if the newly received NAV is shorter than the NAV set for the station, the station does not needs to perform updating.

In this embodiment, an example of setting a NAV is used to describe a process of reserving the at least two discontinuous time periods, but the present invention is not limited thereto.

In this embodiment, a transmit station sends a channel reserved frame used for reserving at least two discontinuous time periods, so that multiple discontinuous time periods can be flexibly reserved by performing channel contention once to implement channel reservation in some discontinuous data transmission scenarios, contention overheads are reduced, channel resources are saved, and it is convenient for the transmit station to communicate with a target station in reserved multiple discontinuous time periods.

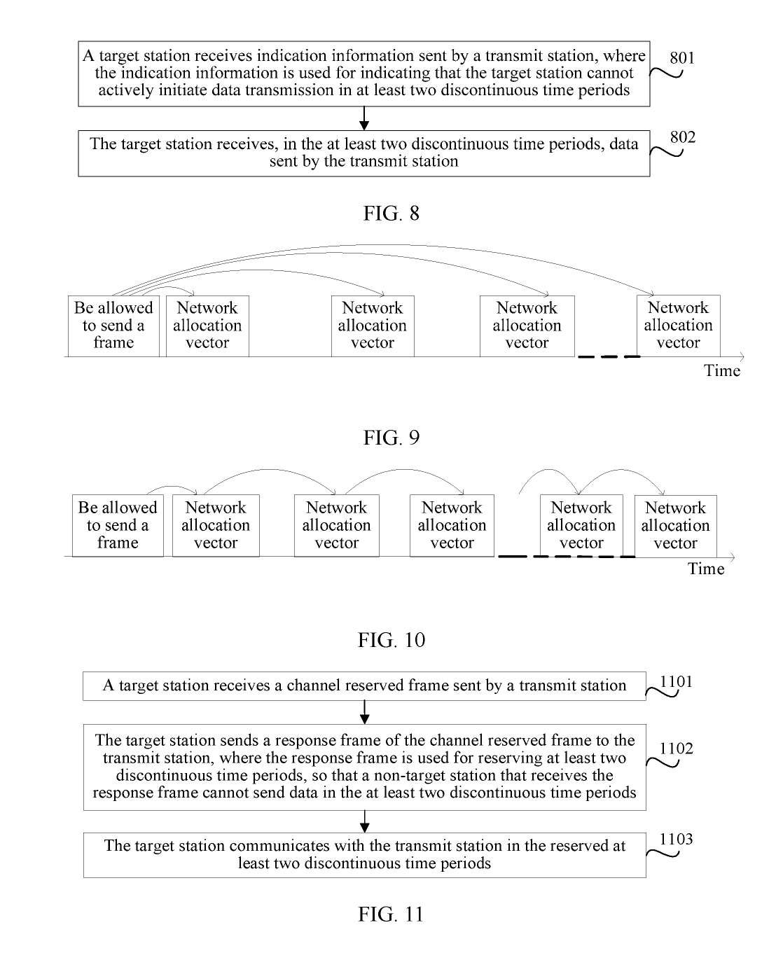

FIG. 8 is a schematic flowchart of Embodiment 3 of an information sending method according to the present invention. As shown in FIG. 8, the method in this embodiment may include the following steps:

Step 801: A target station receives indication information sent by a transmit station, where the indication information is used for indicating that the target station cannot actively initiate data transmission in at least two discontinuous time periods.

In this embodiment of the present invention, the target station receives the indication information that is sent by the transmit station and that is used for indicating that the target station cannot actively initiate data transmission in the at least two discontinuous time periods, where the indication information may be a reserved frame such as an RTS frame, a CTS-to-self frame, or a data frame. Optionally, the indication information may be sent by using one frame, where the frame includes information used for indicating the at least two discontinuous time periods; or the indication information is sent by using at least two frames, where the at least two frames each include information used for indicating at least one time period in the at least two discontinuous time periods, and a frame in the at least two frames is sent in a time period indicated by a previous frame.

Step 802: The target station receives, in the at least two discontinuous time periods, data sent by the transmit station.

Optionally, before the receiving, by the target station in the at least two discontinuous time periods, data sent by the transmit station, the method further includes:

returning, by the target station, response information to the transmit station, where the response information is used for indicating that a receive station cannot actively initiate data transmission in the at least two discontinuous time periods.

Specifically, the returning, by the target station, response information to the transmit station includes: if the indication information is sent by using one frame, sending, by the target station, one response frame to the transmit station; or

if the indication information is sent by using at least two frames, where the at least two frames each include information used for indicating at least one time period in the at least two discontinuous time periods, sending, by the target station, at least two response frames to the transmit station correspondingly.

In this embodiment, after correctly receiving the indication information that is sent by the transmit station by using a frame, the target station needs to return the response information, where the response information may correspondingly be a response frame such as a CTS frame corresponding to an RTS frame, or an ACK frame corresponding to a data frame, and a MAC header of the response frame also carries a Duration field used for setting a NAV. The response frame corresponds to the channel reserved frame, and there may be one or more response frames. Correspondingly, if the indication information is sent by using one frame, the target station sends one response frame to the transmit station, where a MAC header of the response frame may carry multiple Duration fields, that is, the response frame includes information used for indicating the at least two discontinuous time periods, so that a receive station that receives the response frame cannot actively send data in the set at least two discontinuous time periods. If the indication information is sent by using at least two frames, the target station sends at least two response frames to the transmit station correspondingly, where a MAC header of the response frame may carry one or more Duration fields, so that the receive station that receives the response frame cannot actively send data in the set at least two discontinuous time periods, and the receive station is a station that receives the response frame except the transmit station. Information about these Duration fields and information about a Duration field in the received channel reserved frame sent by the transmit station may be the same, or may be different but are used for reserving a same time period.

Optionally, in this embodiment, reserved time period information included in the response frame sent by the target station to the transmit station is consistent with reserved time period information in the reserved frame sent by the transmit station and received by the target station, and a frame format of the response frame of the reserved frame is consistent with a format of the reserved frame, for example, a format such as “a start time 1+duration 1+a start time 2+duration 2+ . . . +a start time n+duration n” or “a start time 1+an end time 1+a start time 2+an end time 2+ . . . +a start time n+an end time n”, where n may be determined according to a specific actual situation, and time information therein is obtained according to an actual application situation. Further, if a start time is omitted in the format of the reserved frame, it indicates that the start time is the default, for example, starting when a current frame ends.

Optionally, in this embodiment, methods for sending, by the target station, the response frame to the transmit station after receiving the reserved frame sent by the transmit station may correspondingly include two types of methods: simultaneous multi-period reservation and stepwise multi-period reservation. In a simultaneous multi-period reservation technology, the target station may send, to the transmit station, one response frame used for indicating that the receive station cannot actively initiate data transmission in the at least two discontinuous time periods, to implement simultaneous multi-period reservation. In a stepwise multi-period reservation technology, the target station may send, to the transmit station at intervals, two response frames used for indicating that the receive station cannot actively initiate data transmission in at least one time period in the at least two discontinuous time periods, where a latter response frame in the at least two response frames is sent in a time period indicated by a former response frame.

For the first simultaneous multi-period reservation technology, FIG. 9 is a schematic diagram 1 of Embodiment 3 of the information sending method according to the present invention. As shown in FIG. 9, in this embodiment, after receiving the reserved frame sent by the transmit station, the target station sends a response frame of the reserved frame to the transmit station, where the response frame is a CTS frame corresponding to an RTS frame, a MAC header of the CTS frame also carries at least two Duration fields, and the field is used for setting a NAV, that is, the response frame is used for indicating that a station that receives the response frame cannot actively initiate data transmission in the at least two discontinuous time periods, that is, after receiving the response frame, the station that receives the response frame sets duration indicated by each of these Duration fields to a NAV value, and ensures that the station cannot send data in the set at least two discontinuous time periods. Information about these Duration fields and information about the Duration field in the received reserved frame sent by the transmit station may be the same, or may be different but are used for reserving a same time period.

In the second stepwise multi-period reservation technology, FIG. 10 is a schematic diagram 2 of Embodiment 3 of the information sending method according to the present invention. As shown in FIG. 10, in this embodiment, after receiving the channel reserved frame sent by the transmit station, the target station first sends a response frame of the reserved frame to the transmit station, where the response frame is a CTS frame corresponding to an RTS frame, a MAC header of the CTS frame also carries one Duration field, and the field is used for setting a NAV, that is, the response frame is used for reserving one time period, so that a station that receives the response frame sets duration indicated by the Duration field to a NAV value, and ensures that the station cannot send data in the set time period; and then, a next reserved time is set in the reserved time according to the foregoing method, and so on, and more time periods are reserved continually. Information about these Duration fields and information about the Duration field in the received channel reserved frame sent by the transmit station may be the same, or may be different but are used for reserving a same time period.

The technical solutions in this embodiment are applicable to some discontinuous data transmission scenarios, that is, multiple discontinuous time periods may need to be reserved. Discontinuous data transmission may occur in many scenarios, and in the following descriptions of this embodiment, two typical scenarios: a cyclic service scenario and an uplink and downlink communication scenario are used as an example to further explain and describe the foregoing technical solutions of this embodiment.

In the cyclic service scenario, the reserved time period information in the response frame of the reserved frame that is sent by the target station to the transmit station is consistent with the reserved time period information in the reserved frame sent by the transmit station and received by the target station, and the frame format of the response frame of the reserved frame is consistent with the format of the reserved frame, and details are not described herein again in the present invention.

In the uplink and downlink communication scenario in which multiple access points are deployed, a part of an uplink time or a part of a downlink time or a part or all of an uplink time and a downlink time may be reserved, that is, in step 802, the at least two discontinuous time periods are both used for transmitting uplink data, or are both used for transmitting downlink data, or are partially used for transmitting uplink data and partially used for transmitting downlink data.

After a NAV is set for a station, before a current NAV ends, if the station receives a frame carrying a longer NAV, the station updates the NAV; if the newly received NAV is shorter than the NAV set for the station, the station ignores the NAV.

In this embodiment, a target station sends, to a transmit station, indication information used for indicating that the target station cannot actively initiate data transmission in at least two discontinuous time periods, and receives, in the at least two discontinuous time periods, data sent by the transmit station, so that multiple discontinuous time periods are flexibly reserved to implement channel reservation in some discontinuous data transmission scenarios, and channel resources are saved.

FIG. 11 is a schematic flowchart of Embodiment 4 of an information sending method according to the present invention. As shown in FIG. 11, the method in this embodiment may include the following steps:

Step 1101: A target station receives a channel reserved frame sent by a transmit station.

Specifically, the method includes: receiving, by the target station, one channel reserved frame sent by the transmit station; or receiving, by the target station, at least two channel reserved frames that are sent by the transmit station at intervals.

The target station receives the channel reserved frame that is sent by the transmit station and is used for reserving at least two discontinuous time periods, where the channel reserved frame may be an RTS frame, a CTS-to-self frame, a data frame, or have another frame.

Step 1102: The target station sends, to the transmit station, a response frame of the channel reserved frame, where the response frame is used for reserving at least two discontinuous time periods, so that a non-target station that receives the response frame cannot send data in the at least two discontinuous time periods.

Specifically, when the receiving, by the target station, one channel reserved frame sent by the transmit station, correspondingly, the method includes: sending, by the target station, a response frame of the channel reserved frame to the transmit station, where the response frame is used for reserving the at least two discontinuous time periods at one time; or when the receiving, by the target station, at least two channel reserved frames that are sent by the transmit station at intervals, correspondingly, the method includes: sending, by the target station, response frames of the at least two channel reserved frames to the transmit station at intervals, where at least one response frame is used for reserving one time period or reserving the at least two discontinuous time periods at one time, at least one response frame is sent in a time period reserved by using a former response frame and is used for reserving one time period or reserving the at least two discontinuous time periods at one time, and the reserved time periods are discontinuous.

In this embodiment, after correctly receiving the channel reserved frame sent by the transmit station, the target station needs to return a response frame, where the response frame may correspondingly be a CTS frame corresponding to an RTS frame, an ACK frame corresponding to a data frame, or have another frame, and a MAC header of the response frame also carries a Duration field used for setting a NAV. The response frame corresponds to the channel reserved frame, and there may be one or more response frames. Correspondingly, when there is one response frame, a MAC header of the response frame may carry multiple Duration fields. When there are multiple response frames, a MAC header of the response frame may carry one or more Duration fields, so that the non-target station that receives the response frame cannot send data in set at least two discontinuous time periods. Information about these Duration fields and information about a Duration field in the received channel reserved frame sent by the transmit station may be the same, or may be different but are used for reserving a same time period.

Reserved time period information included in the response frame of the channel reserved frame that is sent by the target station to the transmit station is consistent with reserved time period information in the channel reserved frame sent by the transmit station and received by the target station, and a frame format of the response frame of the channel reserved frame is consistent with a format of the channel reserved frame, for example, a format such as “a start time 1+duration 1+a start time 2+duration 2+ . . . +a start time n+duration n” or “a start time 1+an end time 1+a start time 2+an end time 2+ . . . +a start time n+an end time n”, where n may be determined according to a specific actual situation, and time information therein is obtained according to an actual application situation. Further, if a start time is omitted in the format of the channel reserved frame, it indicates that the start time is the default, for example, starting when a current frame ends.

In this embodiment, methods for sending, by the target station, the response frame to the transmit station after receiving the channel reserved frame sent by the transmit station, to reserve the at least two discontinuous time periods may include two types of methods: simultaneous multi-period reservation and stepwise multi-period reservation. In a simultaneous multi-period reservation technology, the target station may send, to the transmit station, one response frame, used for reserving the at least two discontinuous time periods at one time, of the channel reserved frame, to implement simultaneous multi-period reservation. In a stepwise multi-period reservation technology, the target station may send response frames of the at least two channel reserved frames to the transmit station at intervals, where at least one response frame is used for reserving one time period or reserving the at least two discontinuous time periods at one time, at least one response frame is sent in a time period reserved by using a former response frame and is used for reserving one time period or reserving the at least two discontinuous time periods at one time, and the reserved time periods are discontinuous.

For a first simultaneous multi-period reservation technology, in this embodiment, after receiving the channel reserved frame sent by the transmit station, the target station sends a response frame of the channel reserved frame to the transmit station, where the response frame is a CTS frame corresponding to an RTS frame, a MAC header of the CTS frame also carries at least two Duration fields, and the field is used for setting a NAV, that is, the response frame is used for reserving the at least two discontinuous time periods, so that after receiving the response frame, the non-target station that receives the response frame sets duration indicated by each of these Duration fields to a NAV value, and ensures that the non-target station cannot sent data in the set at least two discontinuous time periods. According to the channel reserved frame, information about these Duration fields and information about the Duration field in the received channel reserved frame sent by the transmit station may have a same format, or may have different formats but are used for reserving a same time period. Details are similar to those in FIG. 9, and refer to FIG. 9.

In a second stepwise multi-period reservation technology, in this embodiment, that the target station sends response frames of the at least two channel reserved frames to the transmit station at intervals includes five implementation manners. In a first implementable manner, each response frame is used for reserving one time period, where a latter response frame is sent in a time period reserved by using a former response frame, and the reserved time periods are discontinuous. In a second implementable manner, at least one response frame is used for reserving one time period, at least one response frame is sent in a time period reserved by using a former response frame and is used for reserving one time period, and the reserved time periods are discontinuous. In a third implementable manner, at least one response frame is used for reserving one time period, at least one response frame is sent in a time period reserved by using a former response frame and is used for reserving the at least two discontinuous time periods at one time, and the reserved time periods are discontinuous. In a fourth implementable manner, at least one response frame is used for reserving the at least two discontinuous time periods at one time, at least one response frame is sent in a time period reserved by using a former response frame and is used for reserving one time period, and the reserved time periods are discontinuous. In a fifth implementable manner, at least one response frame is used for reserving the at least two discontinuous time periods at one time, at least one response frame is sent in a time period reserved by using a former response frame and is used for reserving the at least two discontinuous time periods at one time, and the reserved time periods are discontinuous.

For the first implementable manner of the second stepwise multi-period reservation technology, in this embodiment, after receiving the channel reserved frame sent by the transmit station, the target station first sends a response frame of the channel reserved frame to the transmit station, where the response frame is a CTS frame corresponding to an RTS frame, a MAC header of the CTS frame also carries one Duration field, and the field is used for setting a NAV, that is, the response frame is used for reserving one time period, so that after receiving the response frame, the non-target station that receives the response frame sets duration indicated by the Duration field to a NAV value, and ensures that the non-target station cannot send data in the set time period; and then, a next reserved time is set in the reserved time according to the foregoing method, and so on, and more time periods are reserved continually. According to the channel reserved frame, information about these Duration fields and information about the Duration field in the received channel reserved frame sent by the transmit station may have a same format, or may have different formats but are used for reserving a same time period. Details are similar to those in FIG. 10, and refer to FIG. 10.

The technical solutions in this embodiment are applicable to some discontinuous data transmission scenarios, that is, multiple discontinuous time periods may need to be reserved. Discontinuous data transmission may occur in many scenarios, and in the following descriptions of this embodiment, two typical scenarios: a cyclic service scenario and an uplink and downlink communication scenario are used as an example to further explain and describe the foregoing technical solutions of this embodiment.

In the cyclic service scenario, the reserved time period information in the response frame of the channel reserved frame that is sent by the target station to the transmit station is consistent with the reserved time period information in the channel reserved frame sent by the transmit station and received by the target station, and the frame format of the response frame of the channel reserved frame is consistent with the format of the channel reserved frame, and details are not described herein again in the present invention

In the uplink and downlink communication scenario in which multiple access points are deployed, a part of an uplink time or a part of a downlink time or a part or all of an uplink time and a downlink time may be reserved, that is, in step 1102, the at least two discontinuous time periods are both used for transmitting uplink data, or are both used for transmitting downlink data, or are partially used for transmitting uplink data and partially used for transmitting downlink data.

Step 1103: The target station communicates with the transmit station in the reserved at least two discontinuous time periods.

In this embodiment, the target station receives the channel reserved frame sent by the transmit station and returns the response frame of the channel reserved frame to the transmit station, to set a NAV for the transmit station and all stations surrounding the target station, so that a station for which a NAV is set maintains a silent state in a NAV time, so as to ensure that the target station can communicate with the transmit station without interference in the reserved at least two discontinuous time periods.

After a NAV is set for a station, before a current NAV ends, if the station receives a frame carrying a longer NAV, the station updates the NAV; if the newly received NAV is shorter than the NAV set for the station, the station ignores the NAV.

In this embodiment, a target station sends, to a transmit station, a response frame used for reserving at least two discontinuous time periods, so that multiple discontinuous time periods are flexibly reserved to implement channel reservation in some discontinuous data transmission scenarios, and channel resources are saved, and it is convenient for the target station to communicate with the transmit station in reserved multiple discontinuous time periods.

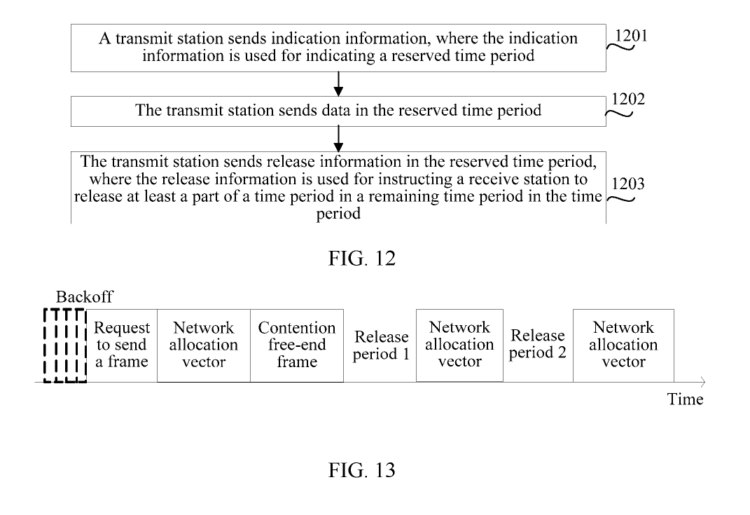

FIG. 12 is a schematic flowchart of Embodiment 5 of an information sending method according to the present invention. As shown in FIG. 12, the method in this embodiment may include the following steps:

Step 1201: A transmit station sends indication information, where the indication information is used for indicating a reserved time period.

Specifically, the reserved time period is one continuous time period or at least two discontinuous time periods.

In this embodiment, the transmit station sends the indication information after successfully obtaining a channel through contention, where the indication information may be a reserved frame such as an RTS frame, so that a receive station that receives the reserved frame sets duration indicated by a Duration field in the reserved frame to a NAV value, and a station for which a NAV is set maintains a silent state in a NAV time, so as to reserve a time period in which data is sent to the target station. Optionally, the Duration field in the channel reserved frame includes information about the one continuous time period, so as to reserve the one continuous time period; or the Duration field in the channel reserved frame includes information about the at least two discontinuous time periods, so as to reserve the at least two discontinuous time periods.

Step 1202: The transmit station sends data in the reserved time period.

In this embodiment, the transmit station may send data to the target station in the reserved time period, where the reserved time period may be one continuous time period or at least two discontinuous time periods that are reserved after the transmit station successfully obtains a channel through contention once.

Step 1203: The transmit station sends release information in the reserved time period, where the release information is used for instructing a receive station to release at least a part of a remaining time period in the time period.

In this embodiment, a station that successfully sets a NAV for another station is referred to as a TXOP holder, and the station has a sending right in a NAV time. In a possible implementation manner, in a successfully reserved time period, when the TXOP holder has no more data to be sent after sending data in a part of time, but has data to be received/sent in a part or some parts in a second half of the reserved time, that is, when discontinuous data transmission is performed, the TXOP holder may send channel release information in the time period, where the channel release information may be a release frame such as an improved CF-end frame, the release frame carries time period information that is used for instructing the receive station that receives the release frame to release a NAV setting of a part or rest parts in a remaining time period in the reserved time period, that is, the frame is used for instructing the receive station to release a reserved resource in the rest part or the rest parts in the remaining time period in the reserved time period, so as to allow another station to perform channel contention. The released time period information may be obtained according to information in an actual situation, for example, for a cyclic service, may be determined according to information such as a length of a time that needs to be released in which cycles; for uplink and downlink services, may be determined according to information such as time periods that need to be released in the uplink and downlink services, and may be determined according to information such as reserved time periods that need to be released and that may be determined according to a known statistical summary. In another possible implementation manner, in a successfully reserved time period, when the TXOP holder has already sent data completely after sending data in a part of time but there is a remaining reserved time period, the reserved time period may be one continuous time period or at least two discontinuous time periods. The TXOP holder may send a channel release frame after having sent the data completely, so as to instruct a station that receives the channel release frame to release the remaining time period in the reserved time period, so as to allow another station to perform channel contention.

In this embodiment, the release frame sent by the transmit station may be set in multiple formats, for example, a format such as “a release start time 1+a release time length 1+a release start time 2+a release time length 2+ . . . +a release start time n+a release time length n” or “a release start time 1+a release end time 1+a release start time 2+a release end time 2+ . . . +a release start time n+a release end time n”, where n may be determined according to a specific actual situation, and time information therein is obtained according to an actual application situation. Further, if a start time is omitted in the format of the release frame, it indicates that the start time is the default, for example, starting when a current frame ends.

FIG. 13 is a schematic diagram 1 of Embodiment 5 of the information sending method according to the present invention. As shown in FIG. 13, an example in which the release frame is used for releasing two parts of time periods in a remaining time period in the reserved one continuous time period is used. After backoff counting ends, the transmit station sends data in one continuous time period reserved by using a sent RTS reserved frame. When the transmit station has no more data to be sent after a part of time, but has data to be received/sent in two parts in a second half of the reserved time, the station may send a CF-end frame in the reserved one continuous time period, where the channel release frame carries time period information that is used for releasing NAV settings of rest two parts in a remaining time period in the reserved one continuous time period, that is, the channel release frame is used for instructing the station that receives the release frame to release reserved resources, that is, a release period 1 and a release period 2, in the rest two parts in the remaining time period in the reserved one continuous time period, so as to allow another station to perform channel contention.

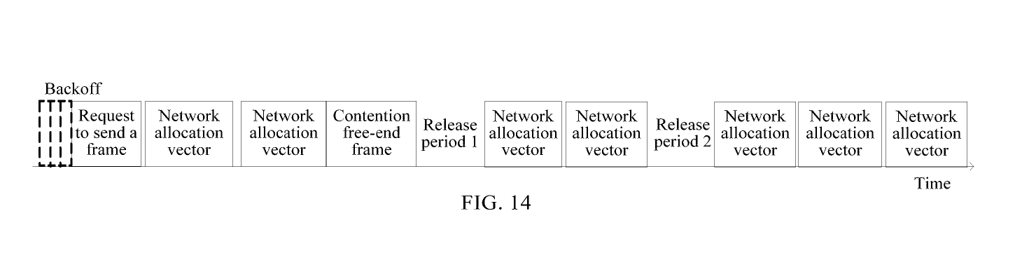

FIG. 14 is a schematic diagram 2 of Embodiment 5 of the information sending method according to the present invention. As shown in FIG. 14, an example in which the channel release frame is used for releasing a part of a time period in the second and the third discontinuous time periods in five reserved discontinuous time periods is used. When the transmit station has no more data to be sent in a middle part of a second time period and a middle part of a third time period after the transmit station sends, after backoff counting ends, data in a first time period and a second time period that are discontinuous and that are reserved by using a sent RTS channel reserved frame, but has data to be received/sent in a later part of the second time period, an earlier part and a later part of a third time period, a fourth time period, and a fifth time period that are reserved, the station may send a CF-end frame in the reserved second time period, where the channel release frame carries time period information that is used for releasing NAV settings of the middle parts of the second time period and the third time period that are reserved, that is, the channel release frame is used for releasing reserved resources, that is, a release period 1 and a release period 2, in the middle parts of the second time period and the third time periods that are reserved, so as to allow another station to perform channel contention.

Using uplink and downlink communication as an example, if an access point reserves uplink and downlink time periods at one time, but there is little downlink data and an entire downlink time period does not need to be occupied, after downlink data is sent completely, a channel release frame may be sent, where the channel release frame includes information about a downlink time period that needs to be released, so as to release a remaining time in the downlink time period for another access point/station to use.

In this embodiment, a transmit station sends release information for instructing a receive station to release at least a part of a time period in a remaining time period in a time period, so that a remaining channel reserved resource is flexibly released in some discontinuous data transmission scenarios, channel resources are saved, and utilization efficiency of a system is improved.

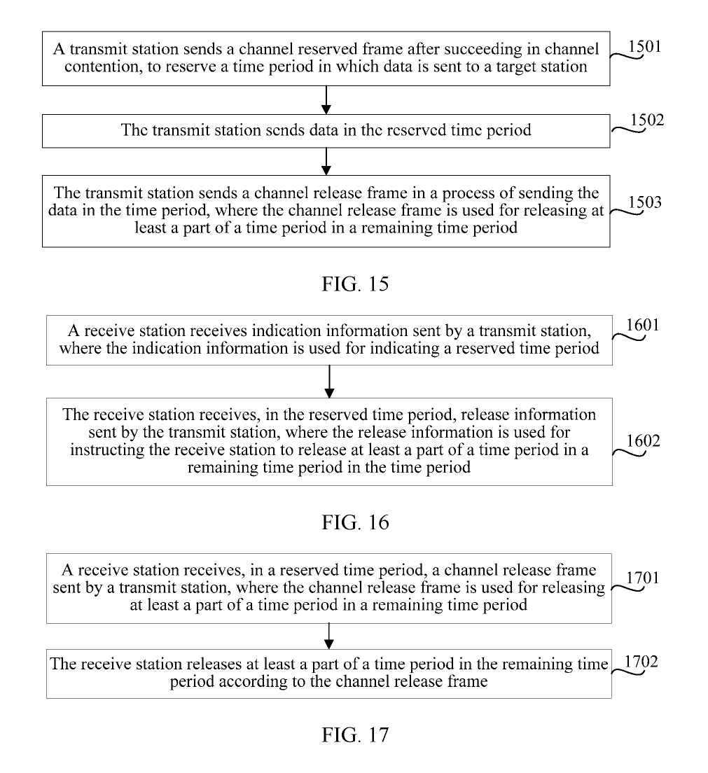

FIG. 15 is a schematic flowchart of Embodiment 6 of an information sending method according to the present invention. As shown in FIG. 15, the method in this embodiment may include the following steps:

Step 1501: A transmit station sends a channel reserved frame after successfully obtaining a channel through contention, to reserve a time period in which data is sent to a target station.

Specifically, the method includes: sending, by the transmit station, the channel reserved frame after successfully obtaining a channel through contention, to reserve one continuous time period; or sending, by the transmit station, the channel reserved frame after successfully obtaining a channel through contention, to reserve at least two discontinuous time periods.

In this embodiment, the transmit station sends the channel reserved frame after successfully obtaining a channel through contention, so that a non-target station that receives the channel reserved frame sets duration indicated by a Duration field in the channel reserved frame to a NAV value, and a station for which a NAV is set maintains a silent state in a NAV time, so as to reserve the time period in which data is sent to the target station. Optionally, the Duration field in the channel reserved frame includes information about the one continuous time period, so as to reserve the one continuous time period; or the Duration field in the channel reserved frame includes information about the at least two discontinuous time periods, so as to reserve the at least two discontinuous time periods.

Step 1502: The transmit station sends data in the reserved time period.

Specifically, when the sending, by the transmit station, the channel reserved frame after successfully obtaining a channel through contention, to reserve one continuous time period is performed, correspondingly, the method includes: sending, by the transmit station, the data in the one continuous time period that is reserved after a channel is successfully obtained through contention; or when the sending, by the transmit station, the channel reserved frame after successfully obtaining a channel through contention, to reserve at least two discontinuous time periods is performed, correspondingly, the method includes: sending, by the transmit station, the data in the at least two discontinuous time periods that are reserved after a channel is successfully obtained through contention.

In this embodiment, the transmit station sends the data in the reserved time period, where the reserved time period may be one continuous time period or at least two discontinuous time periods that are reserved after the transmit station successfully obtains a channel through contention once.

Step 1503: The transmit station sends a channel release frame in a process of sending the data in the time period, where the channel release frame is used for releasing at least a part of a time period in a remaining time period.

Specifically, when the sending, by the transmit station, the channel reserved frame after successfully obtaining a channel through contention, to reserve one continuous time period is performed, and correspondingly, the sending, by the transmit station, the data in the one continuous time period that is reserved after channel contention is successful is performed, correspondingly, the method includes: sending, by the transmit station, the channel release frame in a process of sending the data in the reserved one continuous time period, where the channel release frame is used for releasing at least a part of a time period in a remaining time period of the reserved one continuous time period; or when the sending, by the transmit station, the channel reserved frame after successfully obtaining a channel through contention, to reserve at least two discontinuous time periods is performed, and correspondingly, the sending, by the transmit station, the data in the at least two discontinuous time periods that are reserved after channel contention is successful is performed, correspondingly, the method includes: sending, by the transmit station, the channel release frame in a process of sending the data in the time period, where the channel release frame is used for releasing at least a part of a time period in a remaining time period in the reserved at least two discontinuous time periods.

In this embodiment, a station that successfully sets a NAV for another station is referred to as a TXOP holder, and the station has a sending right in a NAV time. In a possible implementation manner, in a successfully reserved time period, when the TXOP holder has no more data to be sent after sending data in a part of time, but has data to be received/sent in a part or some parts in a second half of the reserved time, that is, when discontinuous data transmission is performed, the TXOP holder may send a channel release frame in the time period, where the channel release frame may be an improved CF-end frame, the channel release frame carries time period information that is used for ending a NAV setting of a part or rest parts in a remaining time period in the reserved time period, that is, the channel release frame is used for releasing a reserved resource in the rest part or the rest parts in the remaining time period in the reserved time period, so as to allow another station to perform channel contention. The released time period information may be obtained according to information in an actual situation, for example, for a cyclic service, may be determined according to information such as a length of a time that needs to be released in which cycles; for uplink and downlink services, may be determined according to information such as time periods that need to be released in the uplink and downlink services, and may be determined according to information such as reserved time periods that need to be released and that may be determined according to a known statistical summary. In another possible implementation manner, in a successfully reserved time period, when the TXOP holder has already sent the data completely after sending data in a part of time but there is a remaining reserved time period, the reserved time period may be one continuous time period or at least two discontinuous time periods. The TXOP holder may send the channel release frame after having sent the data completely, so as to release the remaining time period in the reserved time period, so as to allow another station to perform channel contention.

In this embodiment, the channel release frame sent by the transmit station may be set in multiple formats, for example, a format such as “a release start time 1+a release time length 1+a release start time 2+a release time length 2+ . . . +a release start time n+a release time length n” or “a release start time 1+a release end time 1+a release start time 2+a release end time 2+ . . . +a release start time n+a release end time n”, where n may be determined according to a specific actual situation, and time information therein is obtained according to an actual application situation. Further, if a start time is omitted in the format of the channel release frame, it indicates that the start time is the default, for example, starting when a current frame ends.

In this embodiment of the present invention, an example in which the channel release frame is used for releasing two parts of time periods in a remaining time period in the reserved one continuous time period is used. After backoff counting ends, the transmit station sends data in one continuous time period reserved by using a sent RTS channel reserved frame. When the transmit station has no more data to be sent after a part of time, but has data to be received/sent in two parts in a second half of the reserved time, the station may send a CF-end frame in the reserved one continuous time period, where the channel release frame carries time period information that is used for ending NAV settings of rest two parts in a remaining time period in the reserved one continuous time period, that is, the channel release frame is used for releasing reserved resources, that is, a release period 1 and a release period 2, in the rest two parts in the remaining time period in the reserved one continuous time period, so as to allow another station to perform channel contention. Details are similar to those in FIG. 13, and refer to FIG. 13.

In this embodiment of the present invention, an example in which the channel release frame is used for releasing a part of a time period in the second and the third discontinuous time periods in five reserved discontinuous time periods is used. When the transmit station has no more data to be sent in a middle part of a second time period and a middle part of a third time period after the transmit station sends, after backoff counting ends, data in a first time period and a second time period that are discontinuous and that are reserved by using a sent RTS channel reserved frame, but has data to be received/sent in a later part of the second time period, an earlier part and a later part of a third time period, a fourth time period, and a fifth time period that are reserved, the station may send a CF-end frame in the reserved second time period, where the channel release frame carries time period information that is used for ending NAV settings of the middle parts of the second time period and the third time period that are reserved, that is, the channel release frame is used for releasing reserved resources, that is, a release period 1 and a release period 2, in the middle parts of the second time period and the third time periods that are reserved, so as to allow another station to perform channel contention. Details are similar to those in FIG. 14, and refer to FIG. 14.

Using uplink and downlink communication as an example, if an access point reserves uplink and downlink time periods at one time, but there is little downlink data and an entire downlink time period does not need to be occupied, after downlink data is sent completely, a channel release frame may be sent, where the channel release frame includes information about a downlink time period that needs to be released, so as to release a remaining time in the downlink time period for another access point/station to use.

In this embodiment, a transmit station sends a channel release frame used for releasing at least a part of a time period in a remaining time period, so that a remaining channel reserved resource is flexibly released in some discontinuous data transmission scenarios, channel resources are saved, and utilization efficiency of a system is improved.

FIG. 16 is a schematic flowchart of Embodiment 7 of an information sending method according to the present invention. As shown in FIG. 16, the method in this embodiment may include the following steps:

Step 1601: A receive station receives indication information sent by a transmit station, where the indication information is used for indicating a reserved time period.

Specifically, the reserved time period is one continuous time period or at least two discontinuous time periods.

In this embodiment, the receive station receives the indication information sent by the transmit station, where the receive station is a receive station in all receive stations that receive the indication information except a target station, and the indication information may be a reserved frame such as an RTS frame, and the receive station sets duration indicated by a Duration field in the reserved frame to a NAV value, that is, maintains a silent state in a NAV time, so that the transmit station sends data to the target station without interference in the time period.

Step 1602: The receive station receives, in the reserved time period, release information sent by the transmit station, where the release information is used for instructing the receive station to release at least a part of a remaining time period in the time period.

In this embodiment, the receive station receives, in the reserved time period, the release information sent by the transmit station, where the release information may be a release frame such as an improved CF-end frame, and the channel release frame carries time period information that is used for releasing a NAV setting of a part or some parts in the remaining time period in the reserved time period, that is, the release frame is used for instructing the receive station to release a reserved resource in a part or some parts in the remaining time period in the reserved time period. Specifically, the reserved time period may be one continuous time period or at least two discontinuous time periods, and correspondingly, the release frame carries time period information that is used for releasing a NAV setting of a part or some parts in a remaining time period in the reserved one continuous time periods or in the reserved at least two discontinuous time periods.

Further, the receive station releases, according to the time period information that is used for releasing a NAV setting of a part or some parts in the remaining time period in the reserved time period and that is carried in the release frame, a reserved resource in a corresponding part or corresponding parts in the remaining time period in the reserved time period, so that the receive station can perform channel contention in the released time periods. The reserved time period may be reserved one continuous time period or reserved at least two discontinuous time periods.

In this embodiment, a receive station receives, in a reserved time period, release information that is used for instructing the receive station to release at least a part of a remaining time period in the time period and that is sent by a transmit station, so that a remaining reserved resource is flexibly released in some discontinuous data transmission scenarios, channel resources are saved, and utilization efficiency of a system is improved.

FIG. 17 is a schematic flowchart of Embodiment 8 of an information sending method according to the present invention. As shown in FIG. 17, the method in this embodiment may include the following steps:

Step 1701: A receive station receives, in a reserved time period, a channel release frame sent by a transmit station, where the channel release frame is used for releasing at least a part of a time period in a remaining time period.

Specifically, the method includes: receiving, by the receive station in reserved one continuous time period, the channel release frame sent by the transmit station; or receiving, by the receive station in reserved at least two discontinuous time periods, the channel release frame sent by the transmit station.

In this embodiment, the receive station receives, in the reserved time period, the channel release frame sent by the transmit station, where the channel release frame may be an improved CF-end frame, and the channel release frame carries time period information that is used for ending a NAV setting of a part or some parts in the remaining time period in the reserved time period, that is, the channel release frame is used for releasing a reserved resource in a part or some parts in the remaining time period in the reserved time period. Specifically, the reserved time period may be one continuous time period or at least two discontinuous time periods, and correspondingly, the channel reserved frame carries time period information that is used for ending a NAV setting of a part or some parts in a remaining time period in the reserved one continuous time periods or in the reserved at least two discontinuous time periods.

Step 1702: The receive station releases at least a part of a time period in the remaining time period according to the channel release frame.

Specifically, when the receiving, by the receive station in reserved one continuous time period, the channel release frame sent by the transmit station is performed, correspondingly, the method includes: releasing, by the receive station, at least a part of a time period in a remaining time period in the reserved one continuous time period according to the channel release frame; or when the receiving, by the receive station in reserved at least two discontinuous time periods, the channel release frame sent by the transmit station is performed, correspondingly, the method includes: releasing, by the receive station, at least a part of a time period in a remaining time period in the reserved at least two discontinuous time periods according to the channel release frame.

The receive station releases, according to the time period information that is used for ending a NAV setting of a part or some parts in the remaining time period in the reserved time period and that is carried in the channel release frame, a reserved resource in a corresponding part or corresponding parts in the remaining time period in the reserved time period, so that the receive station can perform channel contention in the released time periods. The reserved time period may be reserved one continuous time period or reserved at least two discontinuous time periods.

In this embodiment, a receive station releases a corresponding time period in a reserved time period according to a channel release frame that is used for releasing at least a part of a time period in a remaining time period in the reserved time period and that is sent by a transmit station, so that a remaining reserved resource is flexibly released in some discontinuous data transmission scenarios, channel resources are saved, and utilization efficiency of a system is improved.

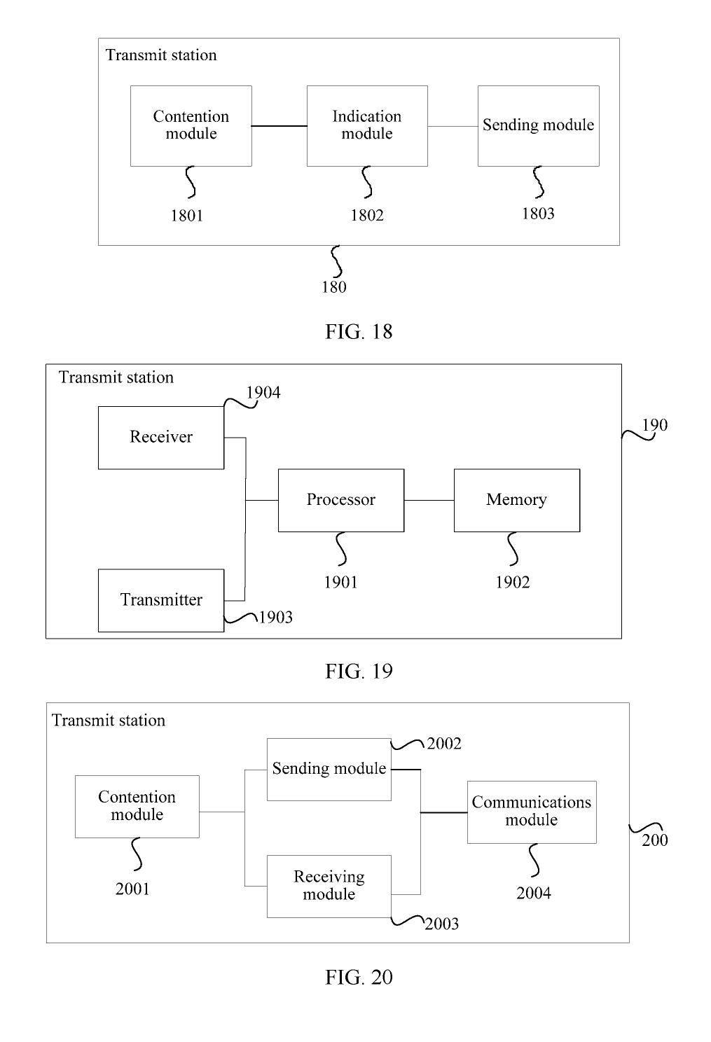

FIG. 18 is a schematic structural diagram of Embodiment 1 of a transmit station 180 according to the present invention. As shown in FIG. 18, the transmit station 180 provided in this embodiment includes: a contention module 1801, an indication module 1802, and a sending module 1803.

The contention module 1801 is configured to perform channel contention.

The indication module 1802 is configured to send indication information after a channel is successfully obtained through contention, where the indication information is used for indicating that a receive station cannot actively initiate data transmission in at least two discontinuous time periods

The sending module 1803 is configured to send data in the at least two discontinuous time periods.

Optionally, the transmit station 180 further includes:

a receiving module, configured to receive response information returned by a target station, where the response information is used for indicating that the receive station cannot actively initiate data transmission in the at least two discontinuous time periods.

Optionally, the indication information is sent by using one frame, where the frame includes information used for indicating the at least two discontinuous time periods; or

the indication information is sent by using at least two frames, where the at least two frames each include information used for indicating at least one time period in the at least two discontinuous time periods, and a frame in the at least two frames is sent in a time period indicated by a previous frame.

Optionally, the transmit station 180 further includes:

a determining module, configured to determine a length of each of the at least two discontinuous time periods according to a cycle of data to be sent and a volume of data to be sent in each cycle.

Optionally, the at least two discontinuous time periods are both used for transmitting uplink data, or are both used for transmitting downlink data, or are partially used for transmitting uplink data and partially used for transmitting downlink data.

The transmit station in this embodiment may be configured to perform the technical solutions of Embodiment 1 of the information sending method; and their implementation principles and technical effects are similar, and details are not described herein again.

FIG. 19 is a schematic structural diagram of Embodiment 2 of a transmit station 190 according to the present invention. As shown in FIG. 19, the transmit station 190 provided in this embodiment includes a processor 1901 and a memory 1902. The transmit station 190 may further include a transmitter 1903 and a receiver 1904. The transmitter 1903 and the receiver 1904 may be connected to the processor 1901. The transmitter 1903 is configured to send data or information. The receiver 1904 is configured to receive data or information. The memory 1901 is configured to store an execution instruction. When the transmit station 190 runs, the processor 1901 communicates with the memory 1902, and the processor 1901 invokes the execution instruction in the memory 1902, and is configured to perform operations in Embodiment 1 of the information sending method.

The transmit station in this embodiment may be configured to perform the technical solutions of Embodiment 1 of the information sending method in the present invention; and their implementation principles and technical effects are similar, and details are not described herein again.

FIG. 20 is a schematic structural diagram of Embodiment 3 of a transmit station 200 according to the present invention. As shown in FIG. 20, the transmit station 200 provided in this embodiment includes: a contention module 2001, a sending module 2002, a receiving module 2003, and a communications module 2004.

The contention module 2001 is configured to perform channel contention.

The sending module 2002 is configured to send a channel reserved frame after a channel is successfully obtained through contention, where the channel reserved frame is used for reserving at least two discontinuous time periods, so that a non-target station that receives the channel reserved frame cannot send data in the at least two discontinuous time periods.

The receiving module 2003 is configured to receive a response frame of the channel reserved frame that is sent by a target station, where the response frame is used for reserving the at least two discontinuous time periods, so that a non-target station that receives the response frame cannot send data in the at least two discontinuous time periods.

The communications module 2004 is configured to communicate with the target station in the reserved at least two discontinuous time periods.

Optionally, the sending module 2002 is specifically configured to send one channel reserved frame after a channel is successfully obtained through contention, where the channel reserved frame is used for reserving the at least two discontinuous time periods;

or

send at least two channel reserved frames at intervals after a channel is successfully obtained through contention, where at least one channel reserved frame is used for reserving one time period or reserving the at least two discontinuous time periods at one time, at least one channel reserved frame is sent in a time period reserved by using a former channel reserved frame and is used for reserving one time period or reserving the at least two discontinuous time periods at one time, and the reserved time periods are discontinuous.

Optionally, the transmit station 200 further includes: a determining module, configured to determine, according to a cycle of service data to be sent and a volume of data to be sent in each cycle, a length of a reserved time period needed in each cycle, where the at least two discontinuous time periods are discontinuous time periods corresponding to each cycle.

Optionally, the at least two discontinuous time periods are both used for transmitting uplink data, or are both used for transmitting downlink data, or are partially used for transmitting uplink data and partially used for transmitting downlink data.

The transmit station in this embodiment may be configured to perform the technical solutions of Embodiment 2 of the information sending method; and their implementation principles and technical effects are similar, and details are not described herein again.

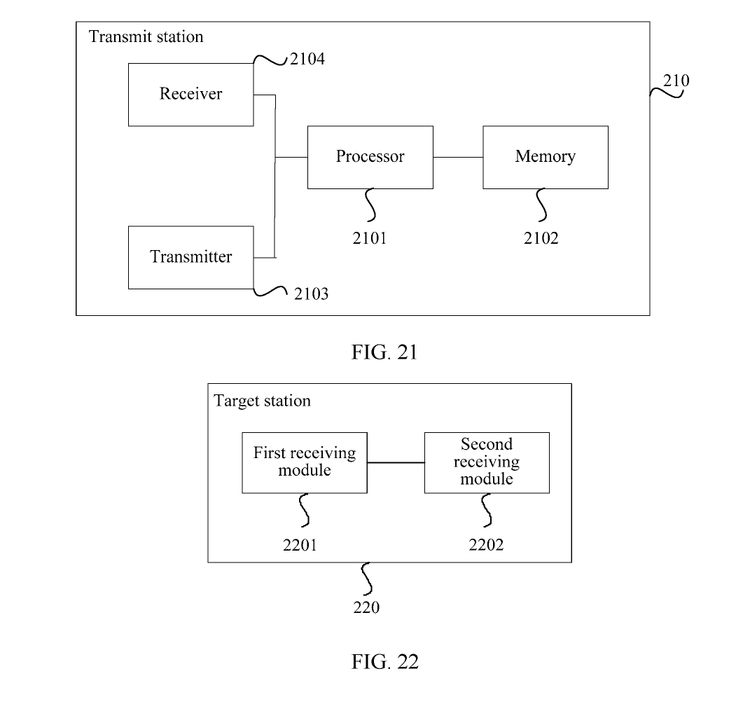

FIG. 21 is a schematic structural diagram of Embodiment 4 of a transmit station 210 according to the present invention. As shown in FIG. 21, the transmit station 210 provided in this embodiment includes a processor 2101 and a memory 2102. The transmit station 210 may further include a transmitter 2103 and a receiver 2104. The transmitter 2103 and the receiver 2104 may be connected to the processor 2101. The transmitter 2103 is configured to send data or information. The receiver 2104 is configured to receive data or information. The memory 2101 is configured to store an execution instruction. When the transmit station 210 runs, the processor 2101 communicates with the memory 2102, and the processor 2101 invokes the execution instruction in the memory, and is configured to perform operations in Embodiment 2 of the information sending method.

The transmit station in this embodiment may be configured to perform the technical solutions of Embodiment 2 of the information sending method in the present invention; and their implementation principles and technical effects are similar, and details are not described herein again.

FIG. 22 is a schematic structural diagram of Embodiment 1 of a target station 220 according to the present invention. As shown in FIG. 22, the target station 220 provided in this embodiment includes: a first receiving module 2201 and a second receiving module 2202.

The first receiving module 2201 is configured to receive indication information sent by a transmit station, where the indication information is used for indicating that the target station cannot actively initiate data transmission in at least two discontinuous time periods.

The second receiving module 2202 is configured to receive, in the at least two discontinuous time periods, data sent by the transmit station.

Optionally, the target station 220 further includes:

a returning module, configured to return response information to the transmit station, where the response information is used for indicating that the receive station cannot actively initiate data transmission in the at least two discontinuous time periods.

Optionally, the returning module is specifically configured to: if the indication information is sent by using one frame, send one response frame to the transmit station; or

if the indication information is sent by using at least two frames, where the at least two frames each include information used for indicating at least one time period in the at least two discontinuous time periods, send at least two response frames to the transmit station correspondingly.

Optionally, the at least two discontinuous time periods are both used for transmitting uplink data, or are both used for transmitting downlink data, or are partially used for transmitting uplink data and partially used for transmitting downlink data.

The target station in this embodiment may be configured to perform the technical solutions of Embodiment 3 of the information sending method; and their implementation principles and technical effects are similar, and details are not described herein again.

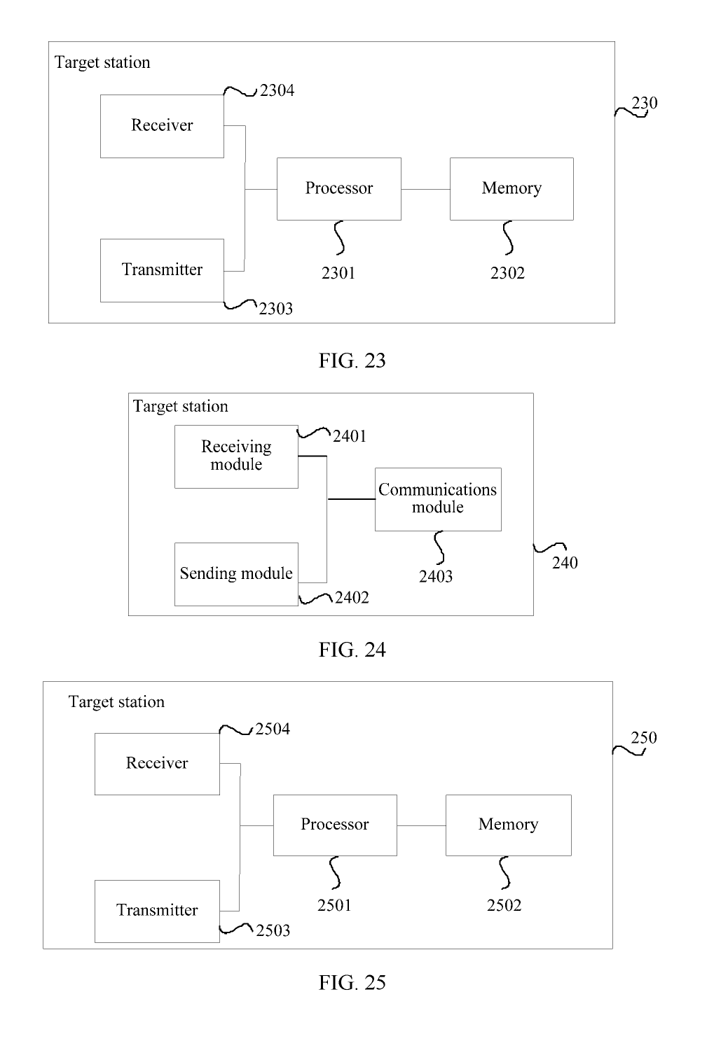

FIG. 23 is a schematic structural diagram of Embodiment 2 of a target station 230 according to the present invention. As shown in FIG. 23, the target station 230 provided in this embodiment includes a processor 2301 and a memory 2302. The target station 230 may further include a transmitter 2303 and a receiver 2304. The transmitter 2303 and the receiver 2304 may be connected to the processor 2301. The transmitter 2303 is configured to send data or information. The receiver 2304 is configured to receive data or information. The memory 2301 is configured to store an execution instruction. When the target station 230 runs, the processor 2301 communicates with the memory 2302, and the processor 2301 invokes the execution instruction in the memory, and is configured to perform operations in Embodiment 3 of the information sending method.

The target station in this embodiment may be configured to perform the technical solutions of Embodiment 3 of the information sending method in the present invention; and their implementation principles and technical effects are similar, and details are not described herein again.

FIG. 24 is a schematic structural diagram of Embodiment 3 of a target station 240 according to the present invention. As shown in FIG. 24, the target station 240 provided in this embodiment includes: a receiving module 2401, a sending module 2402, and a communications module 2403.

The receiving module 2401 is configured to receive a channel reserved frame sent by a transmit station.

The sending module 2402 is configured to send a response frame of the channel reserved frame to the transmit station, where the response frame is used for reserving at least two discontinuous time periods, so that a non-target station that receives the response frame cannot send data in the at least two discontinuous time periods.

The communications module 2403 is configured to communicate with the transmit station in the reserved at least two discontinuous time periods.

Optionally, the receiving module 2401 is specifically configured to receive one channel reserved frame sent by the transmit station; and

correspondingly, the sending module 2402 is specifically configured to send a response frame of the channel reserved frame to the transmit station, where the response frame is used for reserving the at least two discontinuous time periods at one time; or

the receiving module 2401 is specifically configured to receive at least two channel reserved frames that are sent by the transmit station at intervals; and

correspondingly, the sending module 2402 is specifically configured to send response frames of the at least two channel reserved frames to the transmit station at intervals, where at least one response frame is used for reserving one time period or reserving the at least two discontinuous time periods at one time, at least one response frame is sent in a time period reserved by using a former response frame and is used for reserving one time period or reserving the at least two discontinuous time periods at one time, and the reserved time periods are discontinuous.

Optionally, the at least two discontinuous time periods are both used for transmitting uplink data, or are both used for transmitting downlink data, or are partially used for transmitting uplink data and partially used for transmitting downlink data.

The target station in this embodiment may be configured to perform the technical solutions of Embodiment 4 the information sending method; and their implementation principles and technical effects are similar, and details are not described herein again.

FIG. 25 is a schematic structural diagram of Embodiment 4 of a target station 250 according to the present invention. As shown in FIG. 25, the target station 250 provided in this embodiment includes a processor 2501 and a memory 2502. The target station 250 may further include a transmitter 2503 and a receiver 2504. The transmitter 2503 and the receiver 2504 may be connected to the processor 2501. The transmitter 2503 is configured to send data or information. The receiver 2504 is configured to receive data or information. The memory 2501 is configured to store an execution instruction. When the target station 250 runs, the processor 2501 communicates with the memory 2502, and the processor 2501 invokes the execution instruction in the memory, and is configured to perform operations in Embodiment 4 of the information sending method.

The target station in this embodiment may be configured to perform the technical solutions of Embodiment 4 of the information sending method in the present invention; and their implementation principles and technical effects are similar, and details are not described herein again.

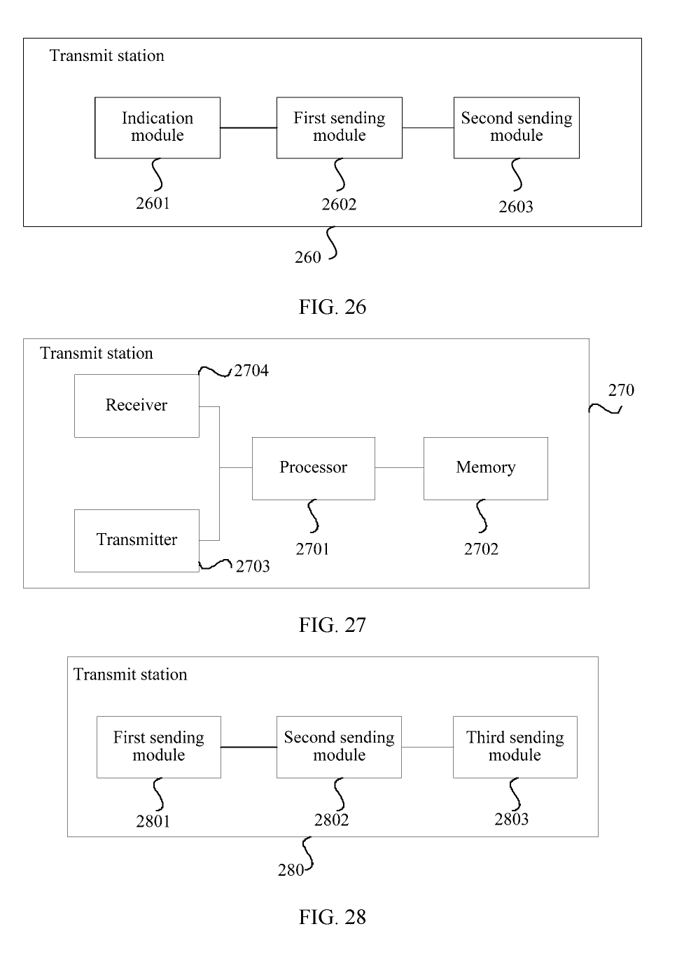

FIG. 26 is a schematic structural diagram of Embodiment 5 of a transmit station 260 according to the present invention. As shown in FIG. 26, the transmit station 260 provided in this embodiment includes: an indication module 2601, a first sending module 2602, and a second sending module 2603.

The indication module 2601 is configured to send indication information, where the indication information is used for indicating a reserved time period.

The first sending module 2602 is configured to send data in the reserved time period.

The second sending module 2603 is configured to send release information in the reserved time period, where the release information is used for instructing a receive station to release at least a part of a remaining time period in the time period.

Optionally, the reserved time period is one continuous time period or at least two discontinuous time periods.

The transmit station in this embodiment may be configured to perform the technical solutions of Embodiment 5 of the information sending method; and their implementation principles and technical effects are similar, and details are not described herein again.

FIG. 27 is a schematic structural diagram of Embodiment 6 of a transmit station 270 according to the present invention. As shown in FIG. 27, the transmit station 270 provided in this embodiment includes a processor 2701 and a memory 2702. The transmit station 270 may further include a transmitter 2703 and a receiver 2704. The transmitter 2703 and the receiver 2704 may be connected to the processor 2701. The transmitter 2703 is configured to send data or information. The receiver 2704 is configured to receive data or information. The memory 2701 is configured to store an execution instruction. When the transmit station 270 runs, the processor 2701 communicates with the memory 2702, and the processor 2701 invokes the execution instruction in the memory, and is configured to perform operations in Embodiment 5 of the information sending method.

The transmit station in this embodiment may be configured to perform the technical solutions of Embodiment 5 of the information sending method in the present invention; and their implementation principles and technical effects are similar, and details are not described herein again.

FIG. 28 is a schematic structural diagram of Embodiment 7 of a transmit station 280 according to the present invention. As shown in FIG. 28, the transmit station 280 provided in this embodiment includes: a first sending module 2801, a second sending module 2802, and a third sending module 2803.

The first sending module 2801 is configured to send a channel reserved frame after a channel is successfully obtained through contention, to reserve a time period in which data is sent to a target station.

The second sending module 2802 is configured to send data in the reserved time period.

The third sending module 2803 is configured to send a channel release frame in a process of sending the data in the time period, where the channel release frame is used for releasing at least a part of a time period in a remaining time period.

Optionally, the first sending module 2801 is specifically configured to send the channel reserved frame after a channel is successfully obtained through contention, to reserve one continuous time period;

correspondingly, the second sending module 2802 is specifically configured to send the data in the one continuous time period that is reserved after a channel is successfully obtained through contention; and

correspondingly, the third sending module 2803 is specifically configured to send the channel release frame in the process of sending the data in the reserved one continuous time period, where the channel release frame is used for releasing at least a part of a time period in a remaining time period of the reserved one continuous time period;

or

the first sending module 2801 is specifically configured to send the channel reserved frame after a channel is successfully obtained through contention, to reserve at least two discontinuous time periods;

correspondingly, the second sending module 2802 is specifically configured to send the data in the at least two discontinuous time periods that are reserved after a channel is successfully obtained through contention; and

correspondingly, the third sending module 2803 is specifically configured to send the channel release frame in the process of sending the data in the time period, where the channel release frame is used for releasing at least a part of a time period in a remaining time period in the reserved at least two discontinuous time periods.

The transmit station in this embodiment may be configured to perform the technical solutions of Embodiment 6 of the information sending method; and their implementation principles and technical effects are similar, and details are not described herein again.

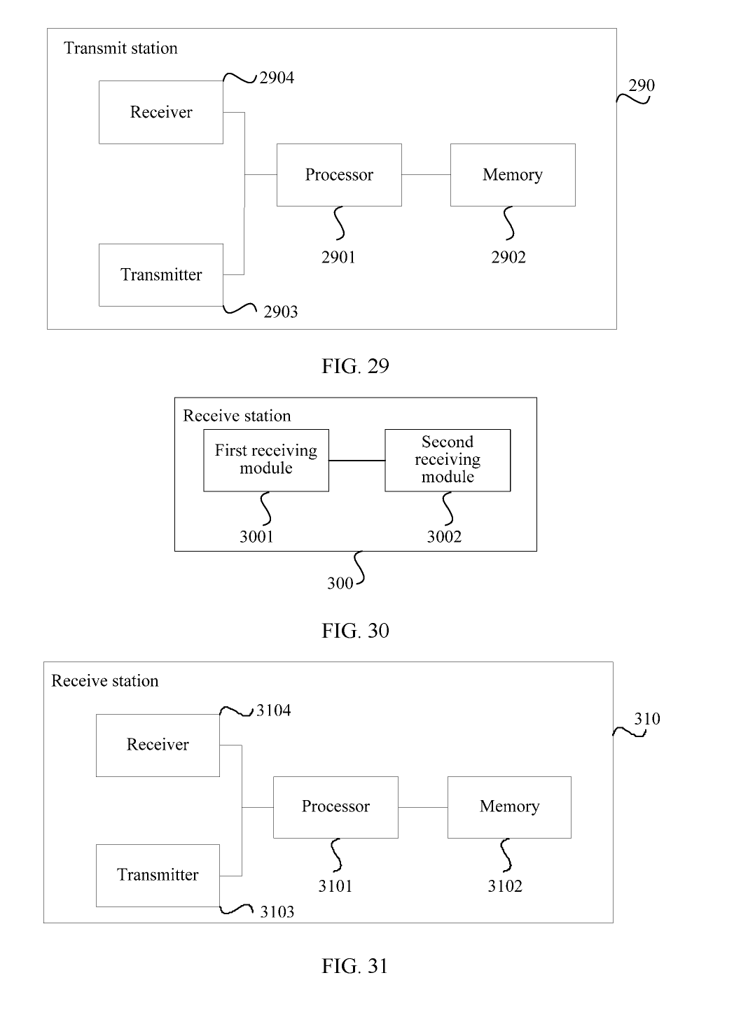

FIG. 29 is a schematic structural diagram of Embodiment 8 of a transmit station 290 according to the present invention. As shown in FIG. 29, the transmit station 290 provided in this embodiment includes a processor 2901 and a memory 2902. The transmit station 290 may further include a transmitter 2903 and a receiver 2904. The transmitter 2903 and the receiver 2904 may be connected to the processor 2901. The transmitter 2903 is configured to send data or information. The receiver 2904 is configured to receive data or information. The memory 2901 is configured to store an execution instruction. When the transmit station 290 runs, the processor 2901 communicates with the memory 2902, and the processor 2901 invokes the execution instruction in the memory, and is configured to perform operations in Embodiment 6 of the information sending method.

The transmit station in this embodiment may be configured to perform the technical solutions of Embodiment 6 of the information sending method in the present invention; and their implementation principles and technical effects are similar, and details are not described herein again.

FIG. 30 is a schematic structural diagram of Embodiment 1 of a receive station 300 according to the present invention. As shown in FIG. 30, the receive station 300 provided in this embodiment includes: a first receiving module 3001 and a second receiving module 3002.

The first receiving module 3001 is configured to receive indication information sent by a transmit station, where the indication information is used for indicating a reserved time period.

The second receiving module 3002 is configured to receive, in the reserved time period, release information sent by the transmit station, where the release information is used for instructing the receive station to release at least a part of a remaining time period in the time period.

Optionally, the reserved time period is one continuous time period or at least two discontinuous time periods.

The receive station in this embodiment may be configured to perform the technical solutions of Embodiment 7 of the information sending method; and their implementation principles and technical effects are similar, and details are not described herein again.

FIG. 31 is a schematic structural diagram of Embodiment 2 of a receive station 310 according to the present invention. As shown in FIG. 31, the receive station 310 provided in this embodiment includes a processor 3101 and a memory 3102. The receive station 310 may further include a transmitter 3103 and a receiver 3104. The transmitter 3103 and the receiver 3104 may be connected to the processor 3101. The transmitter 3103 is configured to send data or information. The receiver 3104 is configured to receive data or information. The memory 3101 is configured to store an execution instruction. When the receive station 310 runs, the processor 3101 communicates with the memory 3102, and the processor 3101 invokes the execution instruction in the memory, and is configured to perform operations in Embodiment 7 of the information sending method.

The receive station in this embodiment may be configured to perform the technical solutions of Embodiment 7 of the information sending method in the present invention; and their implementation principles and technical effects are similar, and details are not described herein again.

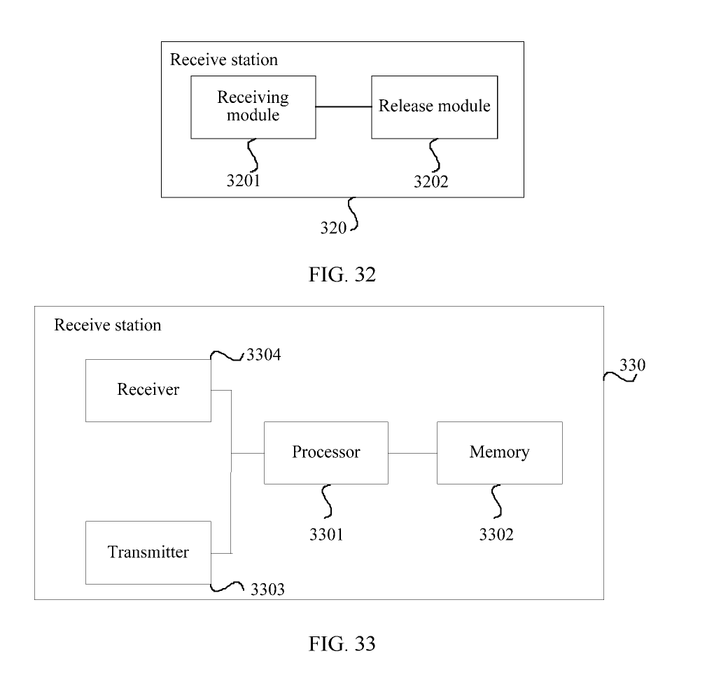

FIG. 32 is a schematic structural diagram of Embodiment 3 of a receive station 320 according to the present invention. As shown in FIG. 32, the receive station 320 provided in this embodiment includes: a receiving module 3201 and a release module 3202.

The receiving module 3201 is configured to receive, in a reserved time period, a channel release frame sent by a transmit station, where the channel release frame is used for releasing at least a part of a time period in a remaining time period.

The release module 3202 is configured to release at least a part of a time period in the remaining time period according to the channel release frame.

Optionally, the receiving module 3201 is specifically configured to receive, in reserved one continuous time period, the channel release frame sent by the transmit station; and

correspondingly, the release module 3202 is specifically configured to release at least a part of a time period in a remaining time period in the reserved one continuous time period according to the channel release frame;

or

the receiving module 3201 is specifically configured to receive, in reserved at least two discontinuous time periods, the channel release frame sent by the transmit station; and

correspondingly, the release module 3202 is specifically configured to release at least a part of a time period in a remaining time period in the reserved at least two discontinuous time periods according to the channel release frame.

The receive station in this embodiment may be configured to perform the technical solutions of Embodiment 8 of the information sending method; and their implementation principles and technical effects are similar, and details are not described herein again.

FIG. 33 is a schematic structural diagram of Embodiment 4 of a receive station 330 according to the present invention. As shown in FIG. 33, the receive station 330 provided in this embodiment includes a processor 3301 and a memory 3302. The receive station 330 may further include a transmitter 3303 and a receiver 3304. The transmitter 3303 and the receiver 3304 may be connected to the processor 3301. The transmitter 3303 is configured to send data or information. The receiver 3304 is configured to receive data or information. The memory 3301 is configured to store an execution instruction. When the receive station 330 runs, the processor 3301 communicates with the memory 3302, and the processor 3301 invokes the execution instruction in the memory, and is configured to perform operations in Embodiment 8 of the information sending method.

The receive station in this embodiment may be configured to perform the technical solutions of Embodiment 8 of the information sending method in the present invention; and their implementation principles and technical effects are similar, and details are not described herein again.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. An information sending method, comprising:
performing, by a transmit station, channel contention;
sending, by the transmit station, indication information after successfully obtaining a channel through the channel contention, wherein the indication information indicates that a receive station cannot actively initiate data transmission in at least two discontinuous time periods; and
sending, by the transmit station, data in the at least two discontinuous time periods.

2. The method according to claim 1, before the sending, by the transmit station, the data in the at least two discontinuous time periods, further comprising:
receiving, by the transmit station, response information returned by a target station, wherein the response information is used for indicating that a receive station cannot actively initiate data transmission in the at least two discontinuous time periods.

3. The method according to claim 1, wherein the indication information is sent by using one frame, wherein the frame comprises information indicating the at least two discontinuous time periods; or
the indication information is sent by using at least two frames, wherein the at least two frames each comprises information indicating at least one time period in the at least two discontinuous time periods, and a frame in the at least two frames is sent in a time period indicated by a previous frame.

4. The method according to claim 1, before the sending, by the transmit station, the indication information, further comprising:
determining, by the transmit station, a length of each of the at least two discontinuous time periods according to a cycle of data to be sent and a volume of data to be sent in each cycle.

5. The method according to claim 1, wherein the at least two discontinuous time periods are both used for transmitting uplink data, or are both used for transmitting downlink data, or are partially used for transmitting the uplink data and partially used for transmitting the downlink data.

6. An information sending method, comprising:
receiving, by a target station, indication information sent by a transmit station, wherein the indication information indicates that the target station cannot actively initiate data transmission in at least two discontinuous time periods; and
receiving, by the target station in the at least two discontinuous time periods, data sent by the transmit station.

7. The method according to claim 6, before the receiving, by the target station in the at least two discontinuous time periods, the data sent by the transmit station, further comprising:
returning, by the target station, response information to the transmit station, wherein the response information is used for indicating that a receive station cannot actively initiate data transmission in the at least two discontinuous time periods.

8. The method according to claim 7, wherein the returning, by the target station, the response information to the transmit station comprises one of:
if the indication information is sent by using one frame, sending, by the target station, one associated response frame to the transmit station; and
if the indication information is sent by using at least two frames, sending, by the target station, at least two associated response frames to the transmit station, wherein the at least two frames each comprises information indicating at least one time period in the at least two discontinuous time periods.

9. The method according to claim 6, wherein the at least two discontinuous time periods are both used for transmitting uplink data, or are both used for transmitting downlink data, or are partially used for transmitting the uplink data and partially used for transmitting the downlink data.

10. An information sending method, comprising:
sending, by a transmit station, indication information, wherein the indication information indicates a reserved time period;
sending, by the transmit station, data in the reserved time period; and
sending, by the transmit station, release information in the reserved time period, wherein the release information instructs a receive station to release at least a part of a remaining time period in the time period.

11. The method according to claim 10, wherein the reserved time period is one continuous time period or at least two discontinuous time periods.

12. An information sending method, comprising:
receiving, by a receive station, indication information sent by a transmit station, wherein the indication information indicates a reserved time period; and
receiving, by the receive station in the reserved time period, release information sent by the transmit station, wherein the release information instructs the receive station to release at least a part of a remaining time period in the time period.

13. The method according to claim 12, wherein the reserved time period is one continuous time period or at least two discontinuous time periods.

14. A transmit station, comprising:
a processor, configured to perform channel contention;
a transmitter, configured to send indication information after a channel is successfully obtained through the channel contention, wherein the indication information indicates that a receive station cannot actively initiate data transmission in at least two discontinuous time periods; and
the transmitter is further configured to send data in the at least two discontinuous time periods.

15. The transmit station according to claim 14, further comprising:
a receiver, configured to receive response information returned by a target station, wherein the response information is used for indicating that a receive station cannot actively initiate data transmission in the at least two discontinuous time periods.

16. A target station, comprising:
a receiver, configured to receive indication information sent by a transmit station, wherein the indication information indicates that the target station cannot actively initiate data transmission in at least two discontinuous time periods; and
receive, in the at least two discontinuous time periods, data sent by the transmit station.

17. The target station according to claim 16, further comprising:
a transmitter, configured to return response information to the transmit station, wherein the response information is used for indicating that a receive station cannot actively initiate data transmission in the at least two discontinuous time periods.

18. The target station according to claim 17, wherein the transmitter is configured to implement one of:
if the indication information is sent by using one frame, sending one associated response frame to the transmit station; and
if the indication information is sent by using at least two frames, wherein the at least two frames each comprises information indicating at least one time period in the at least two discontinuous time periods, sending at least two associated response frames to the transmit station.

19. A transmit station, comprising:
a transmitter, configured to send indication information, wherein the indication information indicates a reserved time period;
send data in the reserved time period; and
send release information in the reserved time period, wherein the release information instructs a receive station to release at least a part of a remaining time period in the time period.

20. A receive station, comprising:
a receiver, configured to receive indication information sent by a transmit station, wherein the indication information indicates a reserved time period; and
receive, in the reserved time period, release information sent by the transmit station, wherein the release information instructs the receive station to release at least a part of a remaining time period in the time period.
